(19) United States
(12) Patent Application Publication
(10) Pub. No.: US 2025/0279939 A1
(43) Pub. Date: Sep. 4, 2025

(54) NETWORK CONTROLLED REPEATER COMMUNICATIONS BASED ON USER EQUIPMENT MACHINE LEARNING ALGORITHMS

(71) Applicant: QUALCOMM Incorporated, San Diego, CA (US)

(72) Inventors: Hua WANG, Basking Ridge, NJ (US); Navid ABEDINI, Basking Ridge, NJ (US); Kapil GULATI, Belle Mead, NJ (US); Junyi LI, Fairless Hills, PA (US)

(21) Appl. No.: 18/592,075

(22) Filed: Feb. 29, 2024

(51) Int. Cl. H04L 41/16; H04W 24/02

(52) U.S. Cl. CPC H04L 41/16; H04W 24/02

(57) ABSTRACT

Methods, systems, and devices for wireless communications are described that provide for a user equipment (UE) to be configured with one or more machine learning (ML) algorithms for predicting communications parameters with a network entity via one or more repeaters that may have multiple different repeater configurations. The UE may select a ML algorithm, select one or more parameters for input to a ML algorithm, process an output of a ML algorithm, or any combination thereof, based on a state or status of one or more repeaters that are used for communications with the network entity. A UE also may request a change in a repeater configuration based on one or more predicted channel characteristics that indicate a configuration change will enhance channel conditions.

### FIELD OF TECHNOLOGY

The following relates to wireless communications, including network controlled repeater communications based on user equipment machine learning algorithms.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support network controlled repeater communications based on user equipment machine learning algorithms. For example, the described techniques provide for a user equipment (UE) to be configured with one or more machine learning (ML) algorithms for predicting communications parameters with a network entity via one or more repeaters that may have multiple different configurations, such as repeater configurations. In some aspects, the UE may select a ML algorithm, select one or more parameters for input to a ML algorithm, process an output of a ML algorithm, or any combination thereof, based on a state or a status (among other criteria) of one or more repeaters that are used for communications with the network entity. In some aspects, the network entity may provide configuration information that indicates one or more ML algorithms, and algorithm selection or parameter selection, associated with different states of repeaters (e.g., on/off repeater states, repeater antenna array states). The UE may change one or more of an ML parameter, or an ML model, or both, based on repeater state, thus enhancing communications reliability and efficiency. Additionally, or alternatively, a UE may request a change in a repeater configuration based on one or more predicted channel characteristics that indicate a configuration change will enhance one or more channel conditions.

A method for wireless communications by a user equipment (UE) is described. The method may include receiving a set of machine learning parameters associated with wireless communications between the UE and a network entity via one or more repeaters, selecting a first subset of the set of machine learning parameters based on a first state of the one or more repeaters, and communicating with the network entity, via the one or more repeaters, using one or more communications parameters that are selected based on the first subset of machine learning parameters.

A UE for wireless communications is described. The UE may include one or more memories storing processor executable code, and one or more processors coupled with the one or more memories. The one or more processors may individually or collectively be operable to execute the code to cause the UE to receive a set of machine learning parameters associated with wireless communications between the UE and a network entity via one or more repeaters, select a first subset of the set of machine learning parameters based on a first state of the one or more repeaters, and communicate with the network entity, via the one or more repeaters, using one or more communications parameters that are selected based on the first subset of machine learning parameters.

Another UE for wireless communications is described. The UE may include means for receiving a set of machine learning parameters associated with wireless communications between the UE and a network entity via one or more repeaters, means for selecting a first subset of the set of machine learning parameters based on a first state of the one or more repeaters, and means for communicating with the network entity, via the one or more repeaters, using one or more communications parameters that are selected based on the first subset of machine learning parameters.

A non-transitory computer-readable medium storing code for wireless communications is described. The code may include instructions executable by one or more processors to receive a set of machine learning parameters associated with wireless communications between the UE and a network entity via one or more repeaters, select a first subset of the set of machine learning parameters based on a first state of the one or more repeaters, and communicate with the network entity, via the one or more repeaters, using one or more communications parameters that are selected based on the first subset of machine learning parameters.

In some examples of the method, UEs, and non-transitory computer-readable medium described herein, the receiving the set of machine learning parameters may include operations, features, means, or instructions for receiving configuration information that indicates the set of machine learning parameters, a set of states associated with the one or more repeaters, and one or more selection criteria that associates different states of the set of states with different subsets of the set of machine learning parameters, and where the set of machine learning parameters include one or more of a set of machine learning algorithms, a set of parameters associated with one or more machine learning algorithms, or any combination thereof. In some examples of the method, UEs, and non-transitory computer-readable medium described herein, the first subset of the set of machine learning parameters may be selected based on a set of available repeater states of the one or more repeaters.

In some examples of the method, UEs, and non-transitory computer-readable medium described herein, the first state of the one or more repeaters may be associated with a first repeater that is in an off state and a second repeater that is in an on state, and output from a machine learning algorithm associated with the first repeater is ignored when the one or more repeaters are in the first state.

Some examples of the method, UEs, and non-transitory computer-readable medium described herein may further include operations, features, means, or instructions for selecting a second subset of the set of machine learning parameters based on the one or more repeaters switching to a second state and communicating with the network entity, via the one or more repeaters, using one or more communications parameters that are determined based on the second subset of machine learning parameters, where the first state is associated with an off duration of a duty cycle of a first repeater of the one or more repeaters and the second state is associated with an on duration of the duty cycle of the first repeater.

In some examples of the method, UEs, and non-transitory computer-readable medium described herein, the second subset of the set of machine learning parameters may be further selected based on a location of the UE within a coverage area of the first repeater. In some examples of the method, UEs, and non-transitory computer-readable medium described herein, the first subset of the set of machine learning parameters may be selected based on a source of one or more reference signals received at the UE. In some examples of the method, UEs, and non-transitory computer-readable medium described herein, the first subset of the set of machine learning parameters may be selected based on an antenna array configuration of at least a first repeater of the one or more repeaters.

A method for wireless communications by a UE is described. The method may include receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters and transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

A UE for wireless communications is described. The UE may include one or more memories storing processor executable code, and one or more processors coupled with the one or more memories. The one or more processors may individually or collectively be operable to execute the code to cause the UE to receive a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters and transmit a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

Another UE for wireless communications is described. The UE may include means for receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters and means for transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

A non-transitory computer-readable medium storing code for wireless communications is described. The code may include instructions executable by one or more processors to receive a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters and transmit a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

Some examples of the method, UEs, and non-transitory computer-readable medium described herein may further include operations, features, means, or instructions for determining a first predicted reference signal received power (RSRP) for a first repeater operating in the first configuration according to the first subset of machine learning parameters, determining a second predicted RSRP for a second repeater operating in the second configuration according to the second subset of machine learning parameters, and determining to transmit the request based on the second predicted RSRP exceeding the first predicted RSRP by a threshold value.

Some examples of the method, UEs, and non-transitory computer-readable medium described herein may further include operations, features, means, or instructions for determining a first predicted RSRP for a first repeater according to the first subset of machine learning parameters when the UE is at a first location within a coverage area of the first repeater, determining a second predicted RSRP for the first repeater according to the second subset of machine learning parameters when the UE is at a second location within the coverage area of the first repeater, and determining to transmit the request based on the second predicted RSRP exceeding the first predicted RSRP by a threshold value.

In some examples of the method, UEs, and non-transitory computer-readable medium described herein, the first configuration may be associated with a first antenna array configuration of at least a first repeater of the one or more repeaters, and the second configuration may be associated with a second antenna array configuration of at least the first repeater.

Some examples of the method, UEs, and non-transitory computer-readable medium described herein may further include operations, features, means, or instructions for measuring a first subset of reference signals from the one or more repeaters according to the first configuration, and a second subset of reference signals from the one or more repeaters according to the second configuration, the second subset of reference signals transmitted during a temporary enablement of the second configuration, and where the request to update the one or more repeaters may be based on the measurements.

Some examples of the method, UEs, and non-transitory computer-readable medium described herein may further include operations, features, means, or instructions for receiving one or more values for one or more inputs for a machine learning algorithm associated with the first configuration and the second configuration, and where the request to update the one or more repeaters may be further based on the one or more values.

In some examples of the method, UEs, and non-transitory computer-readable medium described herein, the transmitting the request may include operations, features, means, or instructions for transmitting a random access channel message to the network entity to request the update of the one or more repeaters from the first configuration to the second configuration, and where the method further includes and switching from the first configuration of the one or more repeaters to the second configuration of the one or more repeaters when the one or more request criteria is met.

In some examples of the method, UEs, and non-transitory computer-readable medium described herein, the transmitting the request may include operations, features, means, or instructions for transmitting an indication of a change in channel conditions and a change in power consumption associated with the request to update the one or more repeaters from the first configuration to the second configuration, and where the method further includes and receiving an indication of whether to update the one or more repeaters from the first configuration to the second configuration.

A method for wireless communications by a network entity is described. The method may include outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters, communicating with the UE in accordance with the first subset of machine learning parameters when the one or more repeaters are configured in the first state, and communicating with the UE in accordance with the second subset of machine learning parameters when the one or more repeaters are configured in the second state.

A network entity for wireless communications is described. The network entity may include one or more memories storing processor executable code, and one or more processors coupled with the one or more memories. The one or more processors may individually or collectively be operable to execute the code to cause the network entity to output a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters, communicate with the UE in accordance with the first subset of machine learning parameters when the one or more repeaters are configured in the first state, and communicate with the UE in accordance with the second subset of machine learning parameters when the one or more repeaters are configured in the second state.

Another network entity for wireless communications is described. The network entity may include means for outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters, means for communicating with the UE in accordance with the first subset of machine learning parameters when the one or more repeaters are configured in the first state, and means for communicating with the UE in accordance with the second subset of machine learning parameters when the one or more repeaters are configured in the second state.

A non-transitory computer-readable medium storing code for wireless communications is described. The code may include instructions executable by one or more processors to output a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters, communicate with the UE in accordance with the first subset of machine learning parameters when the one or more repeaters are configured in the first state, and communicate with the UE in accordance with the second subset of machine learning parameters when the one or more repeaters are configured in the second state.

In some examples of the method, network entities, and non-transitory computer-readable medium described herein, the outputting the set of machine learning parameters may include operations, features, means, or instructions for outputting configuration information that indicates the set of machine learning parameters, a set of states associated with the one or more repeaters, and one or more selection criteria that associates different states of the set of states with different subsets of the set of machine learning parameters, and where the set of machine learning parameters include one or more of a set of machine learning algorithms, a set of parameters associated with one or more machine learning algorithms, or any combination thereof.

A method for wireless communications by a network entity is described. The method may include outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters and obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

A network entity for wireless communications is described. The network entity may include one or more memories storing processor executable code, and one or more processors coupled with the one or more memories. The one or more processors may individually or collectively be operable to execute the code to cause the network entity to output a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters and obtain, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

Another network entity for wireless communications is described. The network entity may include means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters and means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

A non-transitory computer-readable medium storing code for wireless communications is described. The code may include instructions executable by one or more processors to output a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters and obtain, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

In some examples of the method, network entities, and non-transitory computer-readable medium described herein, the obtaining the request may include operations, features, means, or instructions for obtaining a random access channel message to the network entity to request the update of the one or more repeaters from the first configuration to the second configuration, and where the method further includes and switching the one or more repeaters from the first configuration to the second configuration responsive to the random access channel message.

### BRIEF DESCRIPTION OF THE DRAWINGS

FIGS. 1 through 3 show examples of wireless communications systems that support network controlled repeater communications based on user equipment machine learning algorithms in accordance with one or more aspects of the present disclosure.

FIGS. 4 and 5 show examples process flows that support network controlled repeater communications based on user equipment machine learning algorithms in accordance with one or more aspects of the present disclosure.

FIG. 6 shows an example of a block diagram of a machine learning (ML) model represented by an artificial neural network (ANN) that supports network controlled repeater communications based on user equipment machine learning algorithms in accordance with one or more aspects of the present disclosure.

FIGS. 7 and 8 show block diagrams of examples of ML architectures that support network controlled repeater communications based on user equipment machine learning algorithms in accordance with one or more aspects of the present disclosure.

FIGS. 9 and 10 show block diagrams of devices that support network controlled repeater communications based on user equipment machine learning algorithms in accordance with one or more aspects of the present disclosure.

FIG. 11 shows a block diagram of a communications manager that supports network controlled repeater communications based on user equipment machine learning algorithms in accordance with one or more aspects of the present disclosure.

FIG. 12 shows a diagram of a system including a device that supports network controlled repeater communications based on user equipment machine learning algorithms in accordance with one or more aspects of the present disclosure.

FIGS. 13 and 14 show block diagrams of devices that support network controlled repeater communications based on user equipment machine learning algorithms in accordance with one or more aspects of the present disclosure.

FIG. 15 shows a block diagram of a communications manager that supports network controlled repeater communications based on user equipment machine learning algorithms in accordance with one or more aspects of the present disclosure.

FIG. 16 shows a diagram of a system including a device that supports network controlled repeater communications based on user equipment machine learning algorithms in accordance with one or more aspects of the present disclosure.

FIGS. 17 through 24 show flowcharts illustrating methods that support network controlled repeater communications based on user equipment machine learning algorithms in accordance with one or more aspects of the present disclosure.

### DETAILED DESCRIPTION

In some deployments, various devices may communicate with each other via another device, such as a wireless repeater. In such deployments, a wireless repeater may amplify and forward (e.g., transmit) radio frequency (RF) signaling between two devices (e.g., without decoding the RF signaling). For example, a wireless repeater may amplify and forward uplink communications from a user equipment (UE) to a network entity, may amplify and forward downlink communications from the network entity to the UE, or both. A wireless repeater may receive and forward signaling directionally (e.g., using one or more directional beams) and, in some aspects, a network entity may control which directional beams a wireless repeater uses for receiving and forwarding signaling. For example, a wireless repeater, such as a network-controlled repeater (NCR), may receive control information (e.g., via control signaling) from a network entity indicating how the wireless repeater is to directionally receive and forward signaling between the network entity and another device (e.g., a UE). In such examples, the wireless repeater may receive the control information via a mobile termination (MT) functionality of the wireless repeater (e.g., an NCR-MT entity or component) and may use the control information to configure a forwarding functionality of the wireless repeater (e.g., an NCR-FWD entity or component).

In deployments that use such repeaters, a UE may perform wireless communications using one or more communication parameters that are based on a NCR that is repeating signaling and a particular beam that is being used at the NCR. In the event that a repeater configuration changes, such a UE may perform procedures to determine appropriate communication parameters in accordance with the updated repeater configuration. For example, a UE may be communicating via a first repeater using a first set of communication parameters in accordance with a first repeater configuration, and the network may switch to a second repeater configuration in which the UE may communicate via a second repeater using a second set of communication parameters or via the first repeater using a different beam. In order to determine the second set of communication parameters, the UE may perform various measurements and reporting (e.g., reference signal measurements, reporting of reference signal measurements, beam training procedures). Such procedures may take some time to complete, consume processing resources, and consume power and overhead related to the associated measurements and reporting.

In accordance with some aspects, machine learning (ML) techniques may be used to allow a UE to predict one or more communications parameters, which may reduce an amount of time, use fewer processing resources, reduce overhead, and reduce power consumption, associated with determination of communication parameters for an updated configuration (e.g., an updated repeater configuration). For example, ML algorithms may be used to predict one or more of beams for communications, channel state information (CSI), timing advance (TA) values, power control values (e.g., based on predicted path loss), frequency resources, interference, or any combination thereof. In cases where repeaters are used for communications, a relatively large number of potential repeater configurations may be possible (e.g., depending on which repeaters are active or inactive, duty cycles at repeaters used for network energy savings, active beams at different repeaters), and such different configurations may result in a relatively large quantity of different predicted values for communications via the repeaters. In cases where ML algorithms are performed at a network entity to determine communications parameters for multiple UEs, such a relatively large quantity of configurations and models may result in relatively large computational resource usage at the network entity. In some aspects, as discussed herein, UEs may perform such predictions, which may increase usage of computation resources at the UE, however, such additional computational resources may be relatively small if the UE is aware of which ML model(s) to use and potential repeater configurations. Various aspects provided herein provide signaling for indicating the ML models and potential repeater configurations, which may enable efficient UE predictions and associated communications.

In some aspects, UEs may be configured with ML algorithms for predicting communication parameters with one or more network entities via one or more repeaters that may have multiple different repeater configurations. In some aspects, the UE may run one or more selected ML algorithms, using one or more selected parameters, based on a state or status of one or more repeaters that are used for communications with the one or more network entities. In some cases, a network entity may provide configuration information that indicates ML algorithms, algorithm selection, parameter selection, or any combination thereof, associated with different states of repeaters (e.g., on/off repeater states, repeater antenna array states). In some aspects, the UE may autonomously change ML parameters, models, or both, based on repeater state, thus enhancing communications reliability and efficiency. Additionally, or alternatively, a UE may request a change in repeater configuration based on predicted channel characteristics that indicate a configuration change will enhance channel conditions. For example, a UE may request to change a repeater configuration based on a predicted reference signal receive power (RSRP) for a different configuration exceeding a RSRP of a current configuration by a threshold value (e.g., X dB).

Particular implementations of the subject matter described in this disclosure can be implemented to realize one or more of the following potential advantages. For example, as a result of supporting ML algorithms at UEs for predicting communication parameters with one or more network entities via one or more repeaters, communications reliability and efficiency may be enhanced, while reducing overall power consumption and communications overhead. Accordingly, devices using a wireless repeater may achieve or experience greater system capacity, higher data rates, and greater spectral efficiency. Moreover, by establishing mechanisms according to described techniques, a network entity may be able to determine whether to update a repeater configuration, which may further enhance system reliability and efficiency.

Aspects of the disclosure are initially described in the context of wireless communications systems. Aspects of the disclosure are further illustrated by and described with reference to process flows, apparatus diagrams, system diagrams, and flowcharts that relate to network controlled repeater communications based on user equipment machine learning algorithms.

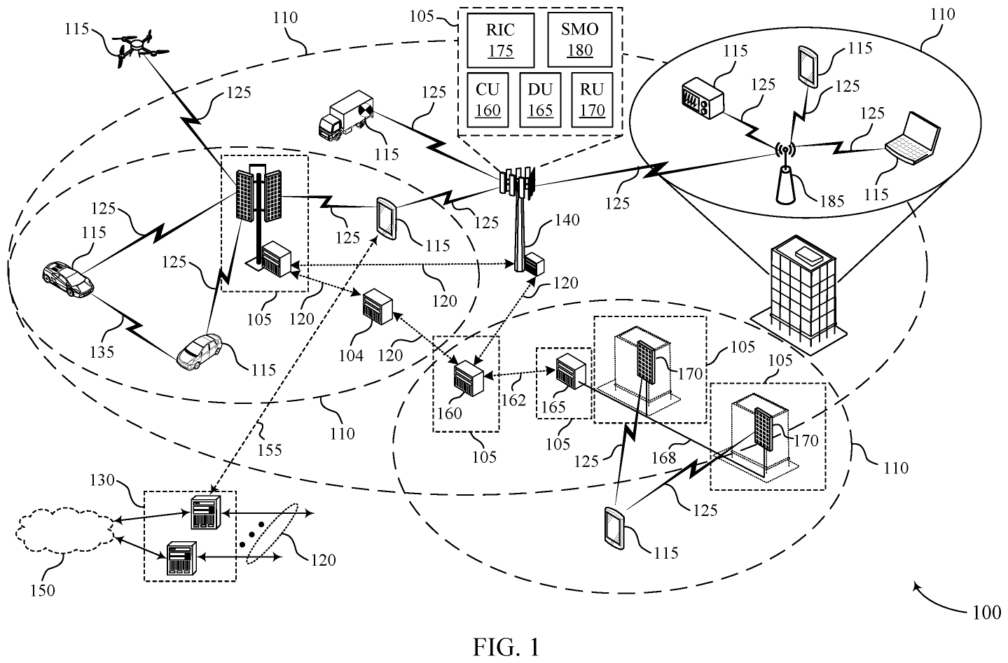

FIG. 1 shows an example of a wireless communications system 100 that supports network controlled repeater communications based on user equipment machine learning algorithms in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects, a UE 115 may be configured with one or more ML algorithms for predicting communications parameters with a network entity 105 via one or more repeaters (e.g., a repeater 185) that may have multiple different repeater configurations. In some aspects, the UE 115 may select a ML algorithm, select one or more parameters for input to a ML algorithm, process an output of a ML algorithm, or any combination thereof, based on a state or status of one or more repeaters 185 that are used for communications with the network entity 105. In some aspects, the network entity 105 may provide configuration information that indicates ML algorithms, and algorithm selection or parameter selection, associated with different states of repeaters (e.g., on/off repeater states, repeater antenna array states). The UE 115 may change one or more of an ML parameter, model, or both, based on repeater state, thus enhancing communications reliability and efficiency. Additionally, or alternatively, a UE 115 may request a change in a repeater configuration based on one or more predicted channel characteristics that indicate a configuration change will enhance channel conditions.

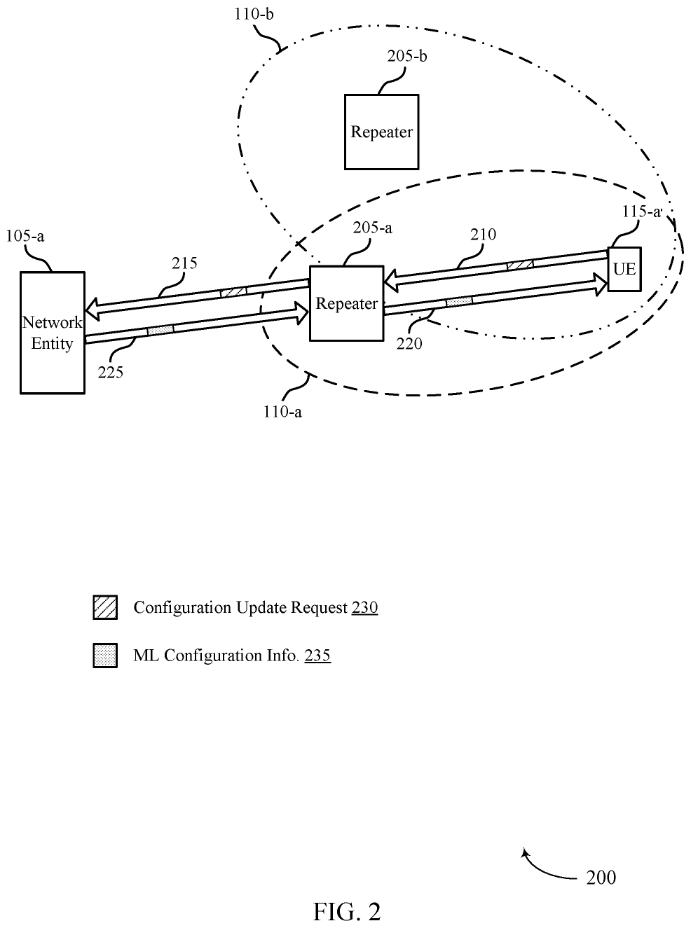

FIG. 2 shows an example of a wireless communications system 200 that supports network controlled repeater communications based on user equipment machine learning algorithms in accordance with one or more aspects of the present disclosure. In some examples, wireless communications system 200 may implement aspects discussed with respect to the wireless communications system 100 illustrated in FIG. 1. For instance, wireless communications system 200 may include a network entity 105-a and a UE 115-a, which may be examples of a network entity 105 and UE 115 as described with reference to FIG. 1. Network entity 105-a may communicate with one or more UEs 115 via one or more repeaters 205. For example, communications may be relayed from the network entity 105-a to UE 115-a (and vice versa) by a first repeater 205-a having a first coverage area 110-a or a second repeater 205-b having a second coverage area 110-b. Repeaters 205 may be examples of a repeater 185 (e.g., a repeater node) described with reference to FIG. 1.

In the example of FIG. 2, first repeater 205-a may relay uplink communications from UE 115-a to the network entity 105-a via communications link 210 and uplink channel 215, and may relay downlink communications from the network entity 105-a to the UE 115-a via downlink channel 225 and the communications link 220. As discussed herein, repeaters 205 may relay signals between network entity 105-a and UE 115-a to enhance coverage for the UE 115, such as by avoiding or reducing blockage or interference. For example, in some cases, there may be an object blocking a signal being transmitted from the network entity 105-a to the UE 115-a, or vice versa. The object may be a physical object or, in some cases, may be an entity that causes interference. Physical objects that may block transmitted signals may include hills, mountains, buildings, walls, other infrastructure, and the like. An interfering device may include another wireless device (e.g., other network entity 105, UEs 115), other types of transmissions or signals (e.g., radar, satellite), or the like, that affect transmissions through adjacent channel selectivity (ACS) jamming, in-band blocking (IBB), and out-of-band (OOB) jamming.

In some aspects, the network entity 105-a may transmit ML configuration information 235 that indicates one or more ML models, one or more ML parameters, one or more configurations, or any combination thereof, via downlink channel 225 and communications link 220. Further, in some cases the UE 115-a may transmit a configuration update request 230 to the network entity 105-a via the first repeater 205-a. For example, configuration update request 230 may request to switch communications for being repeated via the first repeater 205-a to being repeated via the second repeater 205-b.

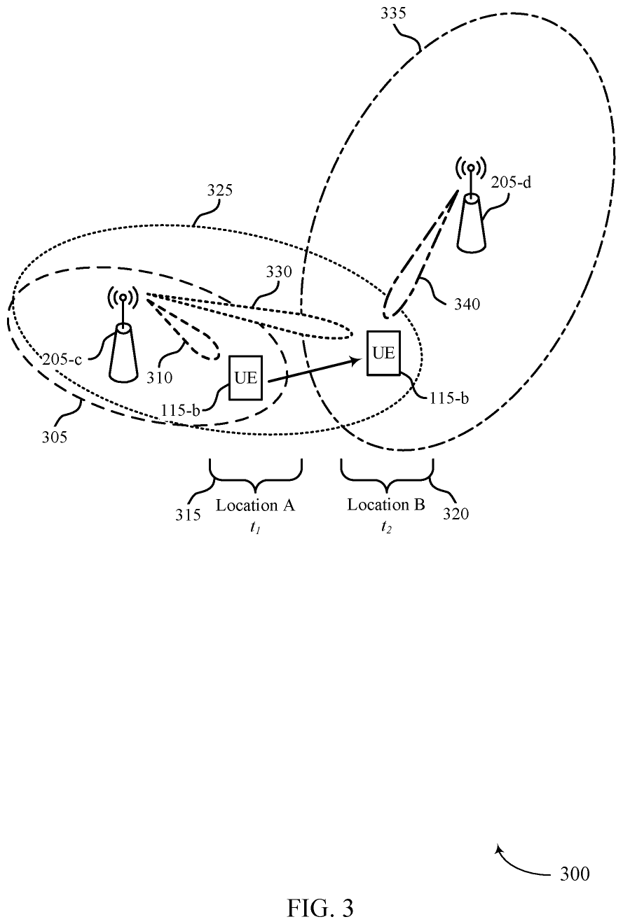

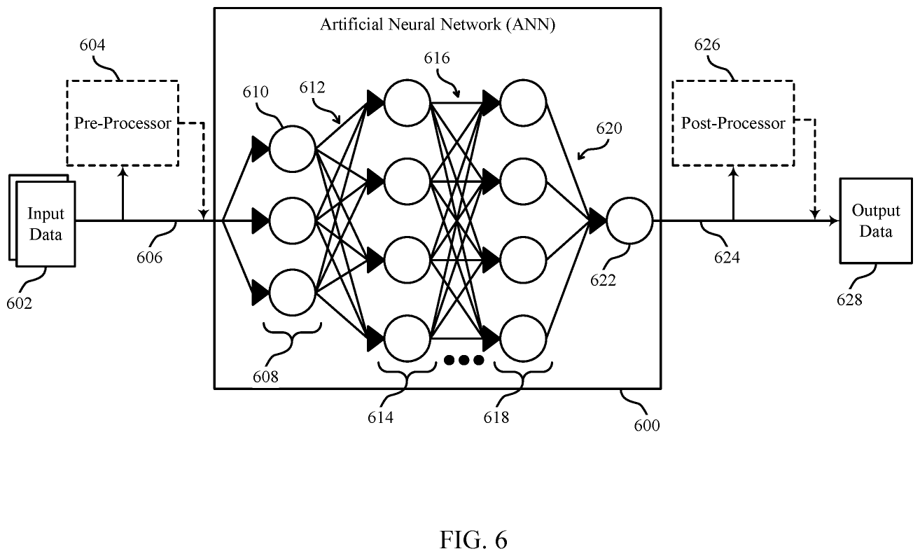

In some aspects, the ML algorithm at the UE 115-a may predict one or more beam-related parameters (e.g., a beam 1D, spatial information, transmit power level), CSI (e.g., precoding matrix indicator (PMI), channel quality indicator (CQI)), TA, power control (e.g., based on pathloss (PL)), frequency resources (e.g., one or more frequency bands for communication), interference levels, or any combination thereof. As discussed, in some cases multiple ML algorithms may be available for use at the UE 115-a, and a ML algorithm may be selected, for example, based on the ML configuration information 235, one or more measured parameters (e.g., RSRP values from two or more repeaters 205), a location of the UE 115-a, or any combination thereof. The output of the selected ML algorithm may be used to assist a determination of, for example, UE association for repeaters 205 (e.g., for handover or load balancing), node configuration (e.g., one or more of on/off state, power levels, or codebook selection). Additionally, or alternatively, the output of the selected ML algorithm may be used to determine which UE 115 of two or more UEs 115 to be served by which repeater 205 (e.g., using a UE and repeater node discover procedure). As discussed herein, the ML algorithm may run at the UE 115-a. In some examples, one or more ML algorithms at the network entity 105-a may also be used to predict the ML configuration information 235 that is provided to the UE 115-a, to predict channel conditions, switch an on/off state of one or more repeaters 205, or any combination thereof. Examples of various ML prediction techniques for communications via one or more repeater nodes are discussed with reference to FIGS. 3 through 5, and examples of ML aspects are discussed with reference to FIGS. 6 through 8.

FIG. 3 shows an example of a wireless communications system 300 that supports network controlled repeater communications based on user equipment machine learning algorithms in accordance with one or more aspects of the present disclosure. In some examples, wireless communications system 300 may implement aspects discussed with respect to the wireless communications systems 100 and 200 illustrated in FIGS. 1 and 2. For instance, wireless communications system 300 may include a UE 115-b, a first repeater 205-c, and a second repeater 205-d, which may be examples of UEs 115, and repeaters 185 and 205, as described with reference to FIGS. 1 and 2. For example, communications may be relayed from a network entity to UE 115-c (and vice versa) by the first repeater 205-c or a second repeater 205-d

In the example of FIG. 3, first repeater 205-c may support communications via multiple beams, including a first beam 310 that may be used for communications when the UE 115-b is located within first coverage area 305 at location A 315. In this example, the UE 115-b may be located at location A 315 at a first time (t₁), and may move to location B 320 at a second time (t₂). When at location B 320, the UE 115-b may be located in a second coverage area 325 of the first repeater 205-c and may use second beam 330 for communications with the first repeater 205-c. Further, when at location B 320, the UE 115-b may be located within third coverage area 335 of the second repeater 205-d, and it may be possible for the UE 115-b to communicate via the second repeater 205-d via third beam 340.

In accordance with various aspects, the UE 115-b may run one or more ML algorithms based on a status of the UE 115-b, a status of the repeaters 205, or both. In some cases, configuration for the ML algorithm selection at the UE 115-b may be controlled or assisted by a network entity (e.g., a network entity 105) that may provide ML configuration information. Based on the ML configuration, the UE 115-b may run different ML algorithms, or run a ML algorithm using different input parameters. In some cases, the selected ML algorithm, associated input parameters, or both, may change based on a duty cycle of the repeaters 205 (e.g., one or more repeaters may periodically switch to an idle mode in accordance with a network energy saving (NES) configuration). In some cases, the UE 115-b may autonomously change the selected ML algorithm, associated input parameters, or both in accordance with the duty cycle. Additionally, or alternatively, the UE 115-b may ignore one or more outputs of a selected ML algorithm based on the repeater 205 configuration (e.g., based on repeaters that are turned off or in an idle state).

Additionally, or alternatively, the UE 115-b may request an update to a configuration of the repeaters 205. For example, upon relocation of the UE 115-b from location A 315 to location B 320, the UE 115-b may request that the second repeater 205-d transition from an idle state to an awake state based on an output of the selected ML algorithm. For example, the selected AL algorithm may predict a first RSRP associated with the second beam 330, and may predict a second RSRP associated with the third beam 340, and if the second RSRP exceeds the first RSRP may a threshold value (e.g., X dB, which may be predefined at the UE 115-b or signaled as part of a configuration of the repeaters 205), the UE 115-b may request to wake up the second repeater 205-d.

Such techniques may enhance efficiency and reliability of communications, such as through predicting various parameters using a ML algorithm at the UE 115-b that may reduce processing resources used at the network entity and reduce delay compared to cases where the ML algorithm may run at the network entity. For example, the UE 115-b may use a selected ML algorithm and one or more measured RSRP values of the first beam 310 (e.g., in a beam set A) to predict one or more RSRP values of the second beam 330 (e.g., in a beam set B) based on movement of the UE 115-b from location A 315 to location B 320. If such a ML algorithm were running at the network entity, or at the first repeater 205-c, the UE 115-b would wait for feedback from a measurement report, which incurs extra signaling and process delay. Further, although running the ML algorithm at the UE 115-b may consume additional processing resources, such an increase may be offset through reduced power consumption associated with reduced signaling between the UE 115-b and repeaters 205 or network entity. Thus, such techniques may distribute power consumption and computation resources across the network, which may provide for relatively balanced network operation. Additionally, if ML algorithms were run exclusively at a network entity or repeater 205, each network entity or repeater 205 may in turn run ML algorithm for a relatively large number of UEs 115 that are being served, which may result in some processing constraints that further increase delay. Accordingly, the more balanced network operation with performance of ML algorithms across multiple devices may further enhance network efficiency.

In some aspects, the UE 115-b may select a ML algorithm, select one or more inputs for a ML algorithm, or both, based on a state of the repeaters 205, such as different repeater 205 on/off states. For example, when operating according to a NES configuration, the second repeater 205-d may be in an off or idle state for a certain period. During such an off-period, the first repeater 205-c may provide communications for each UE 115 in the second coverage area 325, and during an associated on-period of the second repeater 205-d the first repeater 205-c may provide communications only UEs 115 in the first coverage area 305. Thus, depending on the different on/off configurations of the repeaters 205, the intended coverage of the first repeater 205-c may be varied. In such cases, when the repeaters 205 are in a first state, such as when both the first repeater 205-c and the second repeater 205-d are in an on-period, the UE 115-b may run a first ML algorithm or module for predicting beams for both the first repeater 205-c and the second repeater 205-d. In cases where the repeaters 205 are in a first state, such as when the first repeater 205-c is in an on-period and the second repeater 205-d is in an off-period, the UE 115-b may run a second ML algorithm or module for predicting first beam 310 of the first repeater 205-c. Further, if the UE 115-b moves from location A 315 to location B 320, the UE 115-b may run a third ML algorithm (or use a different set of inputs to the second ML algorithm) for predicting second beam 330. Similarly, if the second repeater 205-d is in an on-period when the UE 115-b changes location, the UE may run a fourth ML algorithm for predicting third beam 340. While different ML algorithms are described in this example, in other examples the UE 115-b may use a same ML algorithm with different input parameters provided thereto, or may use the same ML algorithm and ignore one or more outputs based on a location or state of the UE, a state of the repeaters, or both).

In another example, the UE 115-b may select a ML algorithm based on a reference signal configuration of the repeaters 205. In such an example, a reference signal (e.g., a CSI reference signal (CSI RS)) transmitted directly by a network entity (e.g., not via a repeater 205) may be measured at the UE 115-b, and the CSI-RS RSRP measurement value input to the selected ML algorithm. If the reference signal (e.g., CSI-RS) is from a repeater 205, the input to UE 115-b ML algorithm may be the measured CSI-RS RSRP of repeater 205 CSI RS beams, and the UE 115-b may use different ML algorithms based on the different source of CSI-RS. In addition, the UE 115-b may also use sounding reference signal (SRS) RSRP as input to its ML algorithm, and the measured SRS RSRP may be provided to the UE 115-b by the network entity or a repeater 205, and the UE 115-b may select a ML algorithm in accordance with the provided input.

In a further example, the UE 115-b may perform ML algorithm selection based on an antenna or array configuration of one or more repeaters 205. For example, the first repeater 205-c, may operate using multiple array configurations, such as using larger array (e.g., with a larger quantity of antenna elements) for better RSRP or smaller array (e.g., with a smaller quantity of antenna elements) for power saving. In such examples, the UE 115-b may run different ML algorithms based on the array configuration at the first repeater 205-c.

Additionally, or alternatively, the UE 115-b may request a change in a configuration of the repeaters 205. In such aspects, the UE 115-b may run a ML algorithm for a potential better configuration of the repeaters 205, which may be based on the UE 115-b current measurements, historical measurements, or both. For example, the second repeater 205-d may be in an off state, and the UE 115-b may move from location A 315 to location B 320. The UE 115-b may run a first ML algorithm to predict that the first repeater 205-c should use the second beam 330. Further, the UE 115-b may run a second ML algorithm (e.g., based on its location, speed, and past history of being served by the second repeater 205-d) to predict that the second repeater 205-d should use the third beam 340. If the predicted RSRP of being served by third beam 340 exceeds the predicted RSRP of being served by the second beam 330 by a threshold value (e.g., X dB), the UE 115-b may send a message to the network entity to request the network to wake up the second repeater 205-d to serve the UE 115-b using the third beam 340. In such examples, if the predicted difference in RSRP values does not exceed the threshold value, the UE 115-b may continue with communications using the second beam 330 while the second repeater 205-d remains in the off state.

In another example, the first repeater 205-c may serve the UE 115-b using a small array (e.g., a first subset of antenna elements at the first repeater 205-c). The UE 115-b may run a first ML algorithm that predicts, from measured RSRP of a set of beams using small array, one or more preferred serving beams using the small array. The UE 115-b may also run a second ML algorithm using the measured RSRP of the set of beams using the small array to predict one or more preferred serving beams using a larger array (e.g., a second subset of antenna elements at the first repeater 205-c that includes more antenna elements than the first subset of antenna elements). If the predicted RSRP of a beam from the larger array is at least X dB better than the predicted RSRP of a best beam from the smaller array, the UE 115-b may send a message to a network entity to request the first repeater 205-c switch to use the larger array. In some cases, based on the request, the network entity may enable a different configuration of the first repeater 205-c for the UE 115-b to measure reference signals associated with that configuration, and UE 115-b may measure of those reference signals and provide the associated measurement values as input to a corresponding ML algorithm for better prediction. For example, the UE 115-b may predict a best beam of the larger array using measurements of RSs from that larger array, which may provide a more accurate prediction compared to a prediction that uses measurements from the smaller array. Based on the measurements and associated predictions, the network entity may or may not switch the first repeater 205-c configuration.

In some further examples, a network entity may provide additional information to the UE 115-b for use in selection of ML algorithms, selection of inputs for ML algorithms, or both. For example, the network entity may provide an indication of a load of the repeaters 205 as input for the UE 115-b to send a configuration update request (e.g., to turn on a first repeater 205-c beam if the predicted RSRP exceeds predicted RSRPs of a different current serving beam). In some examples, changing of beams used at the first repeater 205-c may result in relatively strong interference to other UEs, and in such cases a threshold value for requesting such a configuration change may be relatively high (e.g., only when RSRP>(current best beam +30 dB)). In some examples, the UE 115-b may transmit the configuration change request as a random access channel (RACH) message, and then autonomously switch to the new configuration when one or more conditions set for sending the change request are met. In some examples, the UE 115-b may report a configuration switch gain (e.g., (RSRP gain)+cost (power)) to the network entity, which may approve or disapprove, and control the configuration in accordance with whether the request was approved or disapproved.

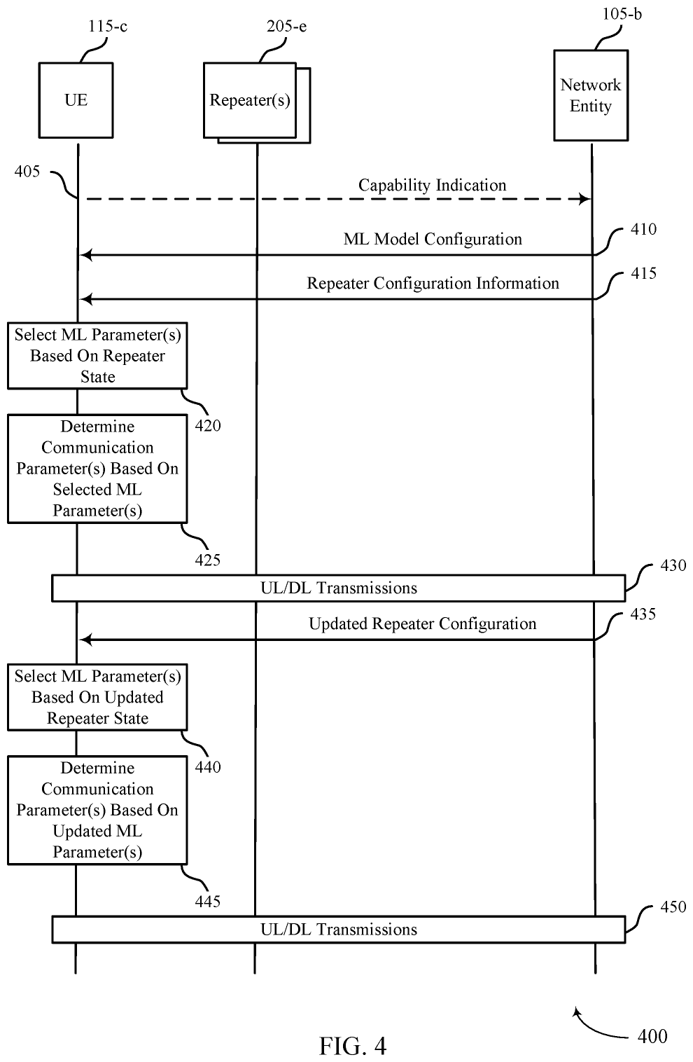

FIG. 4 shows an example of a process flow 400 that supports network controlled repeater communications based on user equipment machine learning algorithms in accordance with one or more aspects of the present disclosure. The process flow 400 may implement or be implemented to facilitate or realize aspects of the wireless communications systems 100, 200, or 300. For example, the process flow 400 illustrates communication between a UE 115-c, a network entity 105-b, and at least one wireless repeater 205-e, which may be examples of corresponding devices illustrated and described herein, including by and with reference to FIGS. 1 through 3. In some implementations, the UE 115-c, the network entity 105, and the wireless repeater 205-e may support one or more signaling or configuration based ML algorithm selection methods with a configuration or state of the wireless repeater 205-e and/or UE 115-c.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the UE 115-c optionally may provide a capability indication to one or more of the repeater 205-e or the network entity 105-b, that indicates a UE 115-c capability for selecting and running ML algorithms. For example, the capability indication may indicate, for example, that the UE 115-c has a capability to select a ML algorithm, a type of assistance information for such selection (e.g., whether an indication of ML algorithms or repeater configuration is to be provided), a quantity of ML algorithms that the UE 115-c is able to run, or any combination thereof. In some cases, such capability signaling may be provided using any one or more of RRC signaling, one or more MAC-CEs, or uplink control information (UCI).

At 410, the network entity 105-b may transmit, and the UE 115-c may receive, a ML model configuration. The ML model configuration may provide one or more ML models or algorithms that are relevant to a current configuration of repeater(s) 205-e. In some cases, the ML model configuration may include one or more ML model IDs, where ML models associated with each ML model ID may be separately provided to the UE 115-c. In some cases, the ML model configuration may be provided using any one or more of RRC signaling, one or more MAC-CEs, or downlink control information (DCI).

At 415, the network entity 105-b may transmit, and the UE 115-c may receive, repeater configuration information that indicates a configuration of repeater(s) 205-e. The repeater configuration information may include, for example, an indication of one or more repeaters 205-e that may be used for communications with the UE 115-c, a state of the one or more repeaters 205, a duty cycle associated with the one or more repeaters 205, an antenna configuration of multiple available antenna configurations for the one or more repeaters 205, or any combination thereof. In some cases, the repeater configuration information may be provided using any one or more of RRC signaling, one or more MAC-CEs, or DCI.

At 420, the UE 115-c may select one or more ML parameters based on a state of the repeater(s) 205-e. For example, the one or more ML parameters may include a ML model or algorithm that is to be used to predict one or more measurements (e.g., predicted RSRP) associated with the repeater(s), one or more ML model inputs (e.g., measured RSRP values), a location associated with the UE 115-b, an on/off state of the repeater(s), and the like.

At 425, the UE 115-c may determine one or more communication parameters based on the selected ML parameters. In some cases, the one or more communication parameters may be one or more of beams for communications, CSI, TA values, power control values (e.g., based on predicted path loss), frequency resources, interference, or any combination thereof.

At 430, the UE 115-c, repeater(s) 205-c, and network entity 105-b, may communicate uplink and downlink transmissions in accordance with the determined communication parameters. The uplink and downlink communications may include, for example, physical downlink control channel (PDCCH) communications, physical downlink shared channel (PDSCH) communications, physical uplink control channel (PUCCH) communications, physical uplink shared channel (PUSCH) communications, RACH communications, paging channel communications, and the like.

At 435, the network entity 105-b may transmit, and the UE 115-c may receive, an updated repeater configuration. For example, the network entity 105-b may turn on or turn off a repeater 205-e, may update an antenna configuration of one or more repeater 205-c, or both, which may be indicated by the updated repeater configuration. In some cases, the updated repeater configuration information may be provided using any one or more of RRC signaling, one or more MAC-CEs, or DCI.

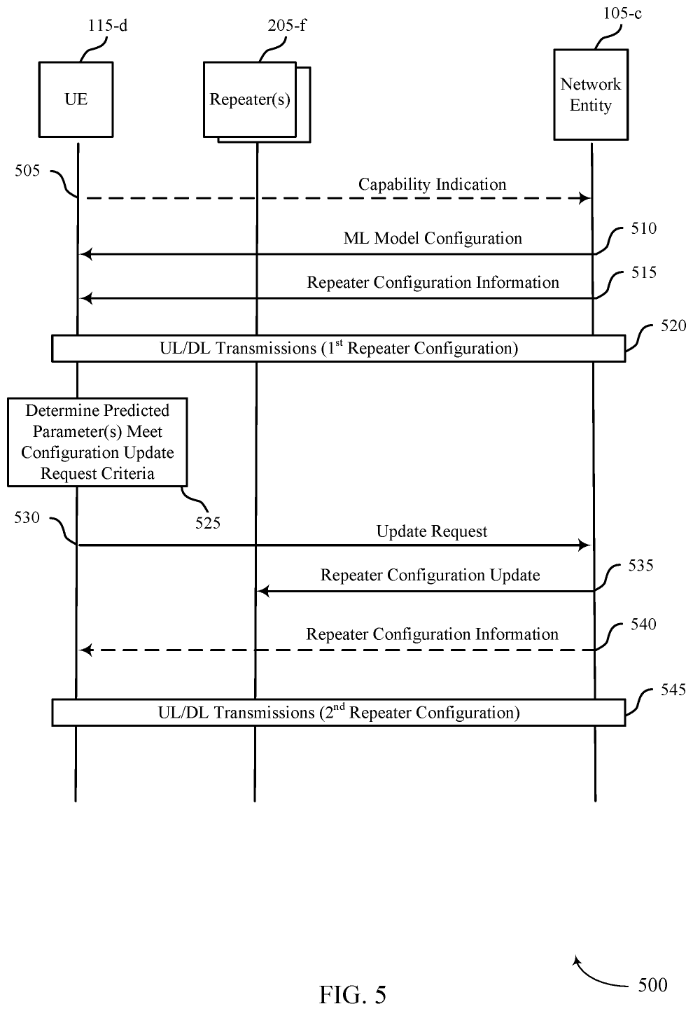

At 440, the UE 115-c may select one or more ML parameters based on the updated state of the repeater(s) 205-c. At 445, the UE 115-c may determine one or more communication parameters based on the updated ML parameters. At 450, the UE 115-c, repeater(s) 205-c, and network entity 105-b, may communicate uplink and downlink transmissions in accordance with the updated communication parameters. As discussed herein, such an update to the repeater configuration may be in response to a request from the UE 115-c, such as discussed in the example of FIG. 5.

FIG. 5 shows an example of a process flow 500 that supports network controlled repeater communications based on user equipment machine learning algorithms in accordance with one or more aspects of the present disclosure. The process flow 500 may implement or be implemented to facilitate or realize aspects of the wireless communications systems 100, 200, or 300. For example, the process flow 500 illustrates communication between a UE 115-d, a network entity 105-c, and at least one wireless repeater 205-f, which may be examples of corresponding devices illustrated and described herein, including by and with reference to FIGS. 1 through 4. In some implementations, the UE 115-d, the network entity 105-c, and the wireless repeater 205-f may support one or more signaling or configuration based ML algorithm selection methods with a configuration or state of the wireless repeater 205-f and/or UE 115-d.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115-d optionally may provide a capability indication to one or more of the repeater 205-f or the network entity 105-c, that indicates a UE 115-d capability for selecting and running ML algorithms. For example, the capability indication may indicate, for example, that the UE 115-d has a capability to request a repeater configuration update, select a ML algorithm, a type of assistance information for such selection (e.g., whether an indication of ML algorithms or repeater configuration is to be provided), a quantity of ML algorithms that the UE 115-d is able to run, or any combination thereof. In some cases, such capability signaling may be provided using any one or more of RRC signaling, one or more MAC-CEs, or UCI.

At 510, the network entity 105-c may transmit, and the UE 115-d may receive, a ML model configuration. The ML model configuration may provide one or more ML models or algorithms that are relevant to a current configuration of repeater(s) 205-f. In some cases, the ML model configuration may include one or more ML model IDs, where ML models associated with each ML model ID may be separately provided to the UE 115-d. In some cases, the ML model configuration may include an indication that the UE 115-d may request repeater configuration updates, may include one or more threshold values for such requests (e.g., a threshold value in dB of predicted RSRP values to trigger a request to update the repeater configuration), or both. In some cases, the ML model configuration may be provided using any one or more of RRC signaling, one or more MAC-CEs, or DCI.

At 515, the network entity 105-c may transmit, and the UE 115-d may receive, repeater configuration information that indicates a configuration of repeater(s) 205-f. The repeater configuration information may include, for example, an indication of one or more repeaters 205-f that may be used for communications with the UE 115-d, a state of the one or more repeaters 205, a duty cycle associated with the one or more repeaters 205, an antenna configuration of multiple available antenna configurations for the one or more repeaters 205, or any combination thereof. In some cases, the repeater configuration information may be provided using any one or more of RRC signaling, one or more MAC-CEs, or DCI.

At 520, the UE 115-d, repeater(s) 205-f, and network entity 105-c, may communicate uplink and downlink transmissions in accordance with a first repeater configuration. The uplink and downlink communications may include, for example, PDCCH communications, PDSCH communications, PUCCH communications, PUSCH communications, RACH communications, paging channel communications, and the like.

At 525, the UE 115-d may determine one or more predicted parameters meet a configuration update request criteria. In some cases, the UE 115-d may compute a difference between a measured RSRP of current communications, and may determine a predicted RSRP for the updated configuration, and compare the different to the associated threshold value, such as discussed with reference to FIG. 3.

At 530, the UE 115-d may transmit, and the network entity 105-c may receive, an update request. The update request may indicate that a different configuration for the repeater(s) 205-f is requested (e.g., a repeater may be requested to be turned on or off, or an antenna array used by a repeater 205-f may be requested to be changed). In some cases, such an update request may be provided using any one or more of RRC signaling, one or more MAC-CEs, UCI, or RACH signaling.

At 535, the network entity 105-c may transmit, and the repeater(s) 205-f may receive, a repeater configuration update. In some cases, the repeater configuration update may be provided to MT functionality of the repeater(s) 205-f, which may cause the repeater(s) 205-f to operate in accordance with the updated configuration.

At 540, optionally, the network entity 105-c may transmit, and UE 115-d may receive, updated repeater configuration information. For example, the network entity 105-c may turn on or turn off a repeater 205-f, may update an antenna configuration of one or more repeater 205-f, or both, which may be indicated by the updated repeater configuration information. In some cases, the updated repeater configuration information may be provided using any one or more of RRC signaling, one or more MAC-CEs, or DCI. At 545, the UE 115-d, repeater(s) 205-f, and network entity 105-c, may communicate uplink and downlink transmissions in accordance with the updated repeater configuration.

As discussed, various aspects may use one or more ML models at one or more of a UE or network entity to determine communication parameters for communications between the UE and network entity via a repeater. FIG. 6 shows an example of a block diagram of an example ML model represented by an artificial neural network (ANN) 600 that supports network controlled repeater communications based on user equipment machine learning algorithms in accordance with one or more aspects of the present disclosure.

Certain aspects and techniques as described herein may be implemented, at least in part, using an artificial intelligence (AI) program, such as a program that includes a ML or ANN model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform prediction of one or more communication parameters for communications between a UE and a network entity via one or more repeaters. Thus, during operation of a device, the ML model may receive input data (such as channel quality measurements, precoder matrix, rank information, RSRP values) and make inferences (such as a compressed channel state information (CSI) report, one or more of beams for communications, TA values, power control values (e.g., based on predicted path loss), frequency resources, interference, or any combination thereof) based on the weights and biases.

ML models may be deployed in one or more devices (for example, network entities and UEs) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models, such as for prediction and selection of communication parameters for communications via repeaters. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In the example of FIG. 6, ANN 600 may receive input data 606 which may include one or more bits of data 602, pre-processed data output from pre-processor 604 (optional), or some combination thereof. Here, data 602 may include training data, verification data, application-related data, or the like, based, for example, on the stage of deployment of ANN 600. Pre-processor 604 may be included within ANN 600 in some other implementations. Pre-processor 604 may, for example, process all or a portion of data 602 which may result in some of data 602 being changed, replaced, deleted, etc. In some implementations, pre-processor 604 may add additional data to data 602. In some implementations, the pre-processor 604 may be a ML model, such as an ANN.

ANN 600 includes at least one first layer 608 of artificial neurons 610 to process input data 606 and provide resulting first layer data via connections or “edges” such as edges 612 to at least a portion of at least one second layer 614. Second layer 614 processes data received via edges 612 and provides second layer output data via edges 616 to at least a portion of at least one third layer 618. Third layer 618 processes data received via edges 616 and provides third layer output data via edges 620 to at least a portion of a final layer 622 including one or more neurons to provide output data 624. All or part of output data 624 may be further processed in some manner by (optional) post-processor 626. Thus, in certain examples, ANN 600 may provide output data 628 that is based on output data 624, post-processed data output from post-processor 626, or some combination thereof.

Post-processor 626 may be included within ANN 600 in some other implementations. Post-processor 626 may, for example, process all or a portion of output data 624 which may result in output data 628 being different, at least in part, to output data 624, as result of data being changed, replaced, deleted, etc. In some implementations, post-processor 626 may be configured to add additional data to output data 624. In this example, second layer 614 and third layer 618 represent intermediate or hidden layers that may be arranged in a hierarchical or other like structure. Although not explicitly shown, there may be one or more further intermediate layers between the second layer 614 and the third layer 618. In some implementations, the post-processor 626 may be a ML model, such as an ANN.

The structure and training of artificial neurons 610 in the various layers may be tailored to specific requirements of an application. Within a given layer such as first layer 608, second layer 614, or third layer 618 of ANN 600, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 600. The weights and biases of ANN 600 may be adjusted during a training process or during operation of ANN 600. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 606. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 600, may be conducted using training data. Training data may include one or more datasets which ANN 600 may use to identify patterns or relationships. Training data may represent various types of information, including written, visual, audio, environmental context, operational properties, etc. During training, the parameters (such as the weights and biases) of artificial neurons 610 may be changed, such as to minimize or otherwise reduce a loss function or a cost function. A training process may be repeated multiple times to fine-tune ANN 600 with each iteration.

ANN 600 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as ANN 600, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

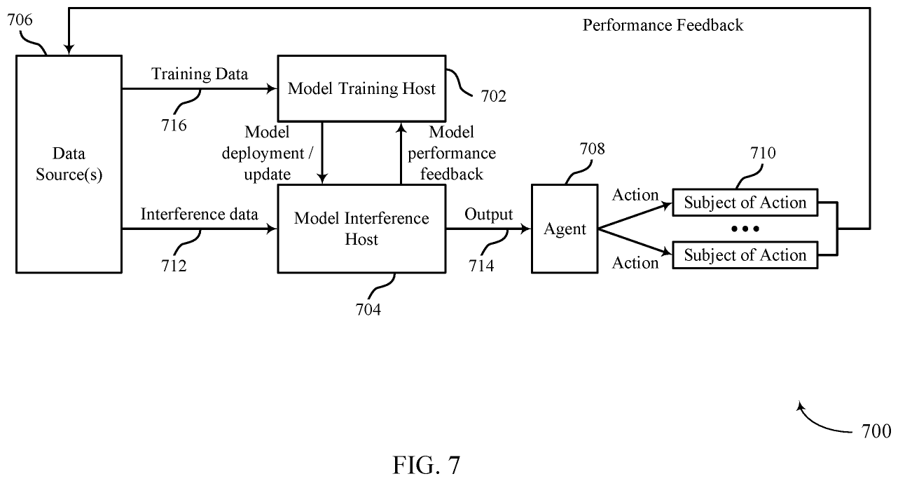

FIG. 7 shows an example of a block diagram of an example ML architecture 700 that supports network controlled repeater communications based on user equipment machine learning algorithms in accordance with one or more aspects of the present disclosure. The example ML architecture 700 may be used for wireless communications in any of the various implementations, processes, environments, networks, or use cases listed above. As illustrated, architecture 700 includes multiple logical entities, such as model training host 702, model inference host 704, data source(s) 706, and agent 708. Model inference host 704 is configured to run an ML model based on inference data 712 provided by data source(s) 706. Model inference host 704 may produce output 714, which may include a prediction or inference, such as a discrete or continuous value based on inference data 712, which may then be provided as input to the agent 708.

Agent 708 may represent an element or an entity of a wireless communication system including, for example, a radio access network (RAN), a wireless local area network, a device-to-device (D2D) communications system, etc. As an example, agent 708 may be a user equipment (such as UE 115, referring to FIGS. 1 through 5, for example), a network entity (such as network entity 105, referring to FIGS. 1 through 5, for example), or a disaggregated network entity (such as a CU160, a DU 165, or a RU 170 referring to FIG. 1, for example), an access point, a wireless station, a RAN intelligent controller (RIC) in a cloud-based RAN, among some examples. Additionally, agent 708 also may be a type of agent that depends on the type of tasks performed by model inference host 704, the type of inference data 712 provided to model inference host 704, or the type of output 714 produced by model inference host 704. For example, if output 714 from model inference host 704 is associated with beam management or communication parameter prediction, agent 708 may be or include a UE, a DU, or an RU.

Data can be collected from data sources 706, and may be used as training data 716 for training an ML model, or as inference data 712 for feeding an ML model inference operation. Data sources 706 may collect data from various subject of action 710 entities (such as, the UE or the network entity), and provide the collected data to a model training host 702 for ML model training. Performance feedback may be used by the model training host 702 for monitoring or evaluating the ML model performance. In some examples, if output 714 provided to agent 708 is inaccurate (or the accuracy is below an accuracy threshold), model training host 702 may provide feedback to model inference host 704 to modify or retrain the ML model used by model inference host 704, such as via an ML model deployment update.

Model training host 702 may be deployed at the same or a different entity than that in which model inference host 704 is deployed. For example, in order to offload model training processing, which can impact the performance of model inference host 704, model training host 702 may be deployed at a model server. In some aspects, an ML model is deployed at or on a UE (such as UE 115) for prediction of one or more communication parameters for communications via one or more repeaters.

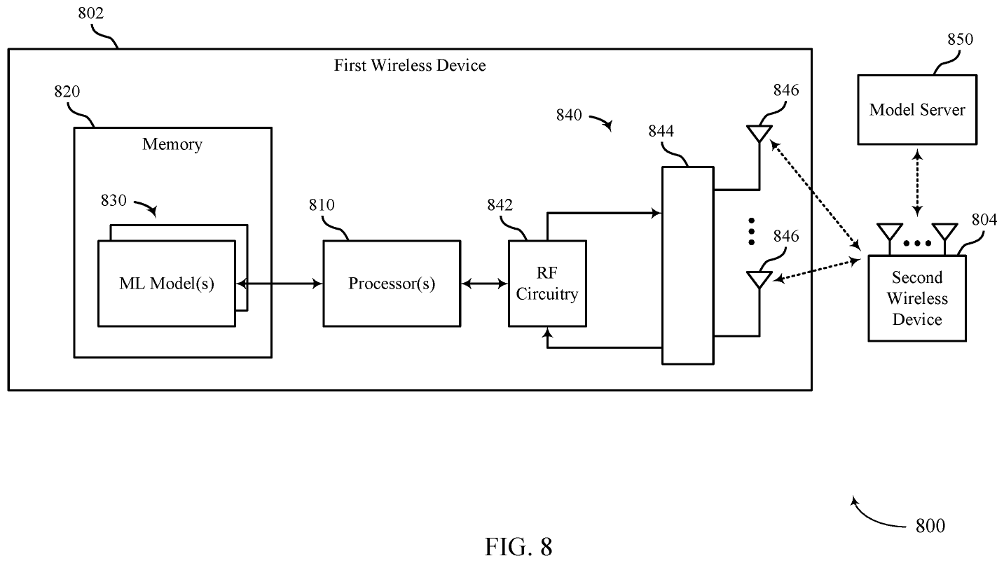

FIG. 8 shows an example of a block diagram of an example ML architecture 800 that supports network controlled repeater communications based on user equipment machine learning algorithms in accordance with one or more aspects of the present disclosure. In this example ML architecture 800 may be implemented in a first wireless device 802 in communication with second wireless device 804. First wireless device 802 may be configured for communications via one or more repeaters with the second wireless device 804. Note that the example ML architecture of first wireless device 802 may be applied to second wireless device 804, and vice versa.

First wireless device 802 may be, or may include, a chip, system on chip (SoC), chipset, package or device that includes one or more processors, processing blocks or processing elements (collectively “processor 810”) and one or more memory blocks or elements (collectively “memory 820”). Processor 810 may be coupled with transceiver 840, which includes radio frequency (RF) circuitry 842 coupled with antennas 846 via interface 844, for transmitting or receiving signals.

One or more ML models 830 (collectively “ML model 830”) may be stored in memory 820 and accessible to processor(s) 810. Individual or groups of ML models 830 may be associated with respective model identifiers. In some aspects, different ML models 830, which may optionally be associated with different model identifiers, may have different characteristics. One or more ML models 830 may be selected based on respective features, characteristics, or applications, as well as characteristics or conditions of first wireless device 802 (such as, a repeater configuration, a power state, a mobility state). For example, ML models 830 may have different inference data and output pairings (such as, different types of inference data produce different types of output), different levels of accuracies associated with the predictions, different latencies associated with producing the predictions, different ML model sizes, different coefficients, different parameters, etc.

Processor 810 may deploy ML models 830 to produce respective output data based on input data. As an example, the ML model 830 may obtain measurements of a reference signal (such as, corresponding to repeater with a first repeater configuration) as input to predict a channel characteristic associated with a different reference signal (such as, corresponding to a second repeater configuration). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a RSRP, a reference signal received quality (RSRQ), and/or a block error rate (BLER). The output data may include, for example, compressed CSI feedback or one or more predicted measurements (or characteristics) of one or more reference or pilot signals.

In some aspects, model server 850 may perform various ML management tasks for first wireless device 802 and/or second wireless device 804. For example, model server 850 may host various types and/or versions of ML models 830 (e.g., for determining communication parameters for communications via one or more repeaters) for first wireless device 802 and/or second wireless device 804 to download. Model server 850 may monitor and evaluate the performance of ML model 830. Model server 850 may transmit signals or provide indications/instructions to activate or deactivate the use of a particular ML model at first wireless device 802 or second wireless device 804. Model server 850 may switch to a different ML model being used at first wireless device 802 or second wireless device 804, and model server 850 may provide such an instruction to the respective first wireless device 802 or second wireless device 804. Model server 850 may operate as a model training host (such as model training host 702) and update ML model 830 using training data. In some cases, the model server 850 may operate as a data source (such as data source 706) to collect and host training data, inference data, performance feedback, etc., associated with ML model 830.

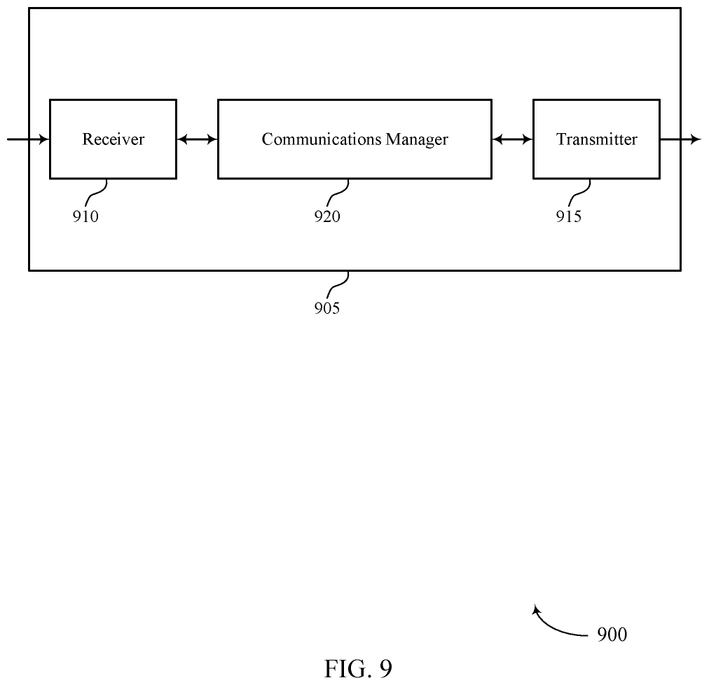

FIG. 9 shows a block diagram 900 of a device 905 that supports network controlled repeater communications based on user equipment machine learning algorithms in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to network controlled repeater communications based on user equipment machine learning algorithms). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to network controlled repeater communications based on user equipment machine learning algorithms). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of network controlled repeater communications based on user equipment machine learning algorithms as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a set of machine learning parameters associated with wireless communications between the UE and a network entity via one or more repeaters. The communications manager 920 is capable of, configured to, or operable to support a means for selecting a first subset of the set of machine learning parameters based on a first state of the one or more repeaters. The communications manager 920 is capable of, configured to, or operable to support a means for communicating with the network entity, via the one or more repeaters, using one or more communications parameters that are selected based on the first subset of machine learning parameters.

Additionally, or alternatively, the communications manager 920 may support wireless communications in accordance with examples as disclosed herein. For example, the communications manager 920 is capable of, configured to, or operable to support a means for receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 920 is capable of, configured to, or operable to support a means for transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

Additionally, or alternatively, the communications manager 920 may support wireless communications in accordance with examples as disclosed herein. For example, the communications manager 920 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 920 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for ML model selection, ML parameter selection, repeater configuration updates, or any combination thereof, that may provide for enhanced efficiency for determination of communications parameters, reduced power consumption, and more efficient utilization of communication resources.

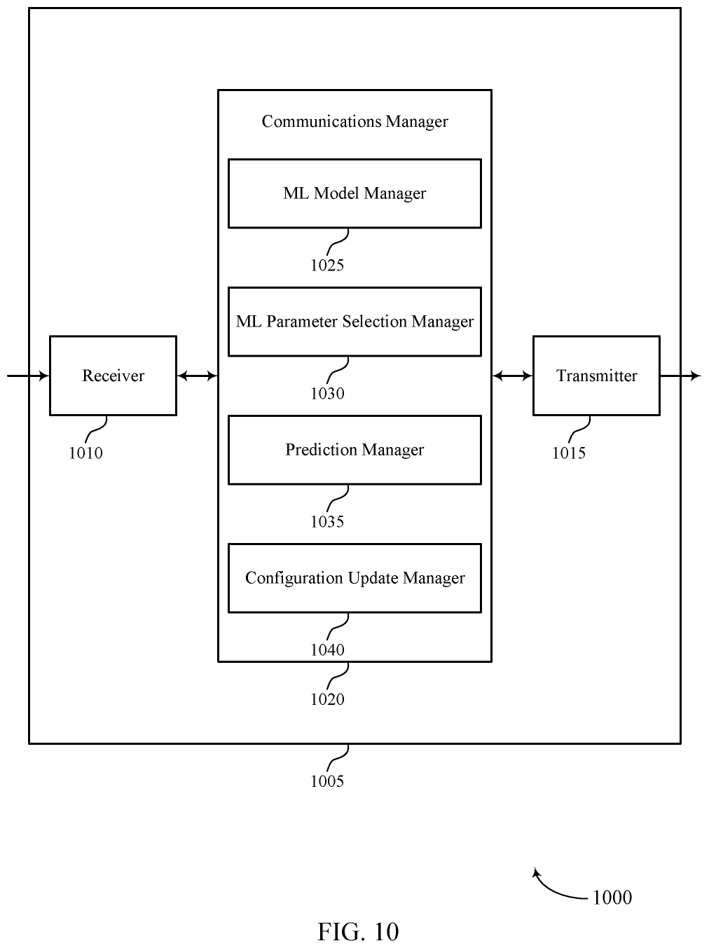

FIG. 10 shows a block diagram 1000 of a device 1005 that supports network controlled repeater communications based on user equipment machine learning algorithms in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to network controlled repeater communications based on user equipment machine learning algorithms). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to network controlled repeater communications based on user equipment machine learning algorithms). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of network controlled repeater communications based on user equipment machine learning algorithms as described herein. For example, the communications manager 1020 may include an ML model manager 1025, an ML parameter selection manager 1030, a prediction manager 1035, a configuration update manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The ML model manager 1025 is capable of, configured to, or operable to support a means for receiving a set of machine learning parameters associated with wireless communications between the UE and a network entity via one or more repeaters. The ML parameter selection manager 1030 is capable of, configured to, or operable to support a means for selecting a first subset of the set of machine learning parameters based on a first state of the one or more repeaters. The prediction manager 1035 is capable of, configured to, or operable to support a means for communicating with the network entity, via the one or more repeaters, using one or more communications parameters that are selected based on the first subset of machine learning parameters.

Additionally, or alternatively, the communications manager 1020 may support wireless communications in accordance with examples as disclosed herein. The ML model manager 1025 is capable of, configured to, or operable to support a means for receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The configuration update manager 1040 is capable of, configured to, or operable to support a means for transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

Additionally, or alternatively, the communications manager 1020 may support wireless communications in accordance with examples as disclosed herein. The ML model manager 1025 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The configuration update manager 1040 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

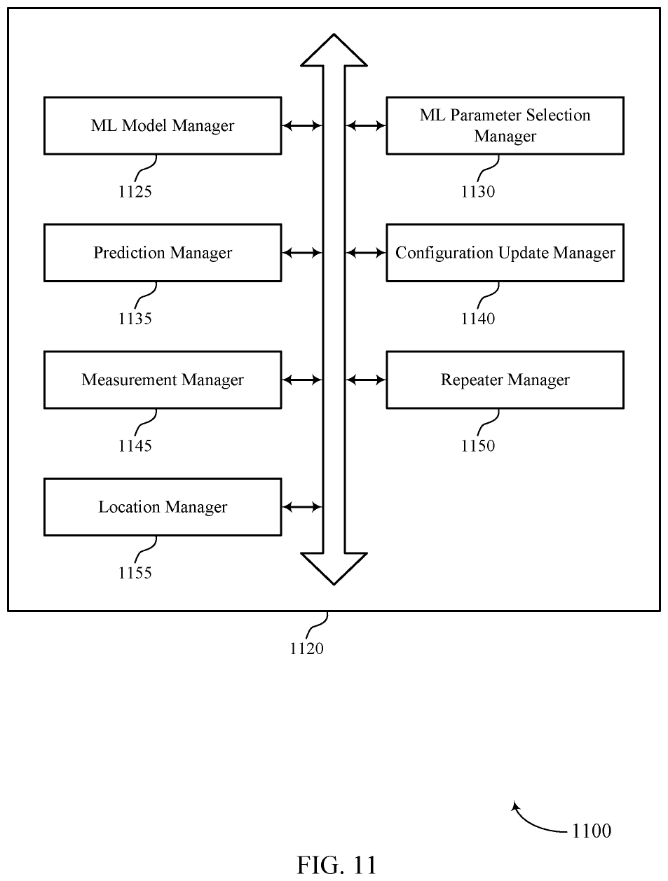

FIG. 11 shows a block diagram 1100 of a communications manager 1120 that supports network controlled repeater communications based on user equipment machine learning algorithms in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of network controlled repeater communications based on user equipment machine learning algorithms as described herein. For example, the communications manager 1120 may include an ML model manager 1125, an ML parameter selection manager 1130, a prediction manager 1135, a configuration update manager 1140, a measurement manager 1145, a repeater manager 1150, a location manager 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The ML model manager 1125 is capable of, configured to, or operable to support a means for receiving a set of machine learning parameters associated with wireless communications between the UE and a network entity via one or more repeaters. The ML parameter selection manager 1130 is capable of, configured to, or operable to support a means for selecting a first subset of the set of machine learning parameters based on a first state of the one or more repeaters. The prediction manager 1135 is capable of, configured to, or operable to support a means for communicating with the network entity, via the one or more repeaters, using one or more communications parameters that are selected based on the first subset of machine learning parameters.

In some examples, to support receiving the set of machine learning parameters, the ML model manager 1125 is capable of, configured to, or operable to support a means for receiving configuration information that indicates the set of machine learning parameters, a set of states associated with the one or more repeaters, and one or more selection criteria that associates different states of the set of states with different subsets of the set of machine learning parameters, and where the set of machine learning parameters include one or more of a set of machine learning algorithms, a set of parameters associated with one or more machine learning algorithms, or any combination thereof.

In some examples, the first subset of the set of machine learning parameters is selected based on a set of available repeater states of the one or more repeaters. In some examples, the first state of the one or more repeaters is associated with a first repeater that is in an off state and a second repeater that is in an on state, and output from a machine learning algorithm associated with the first repeater is ignored when the one or more repeaters are in the first state.

In some examples, the ML parameter selection manager 1130 is capable of, configured to, or operable to support a means for selecting a second subset of the set of machine learning parameters based on the one or more repeaters switching to a second state. In some examples, the prediction manager 1135 is capable of, configured to, or operable to support a means for communicating with the network entity, via the one or more repeaters, using one or more communications parameters that are determined based on the second subset of machine learning parameters, where the first state is associated with an off duration of a duty cycle of a first repeater of the one or more repeaters and the second state is associated with an on duration of the duty cycle of the first repeater.

In some examples, the second subset of the set of machine learning parameters is further selected based on a location of the UE within a coverage area of the first repeater. In some examples, the first subset of the set of machine learning parameters is selected based on a source of one or more reference signals received at the UE. In some examples, the first subset of the set of machine learning parameters is selected based on an antenna array configuration of at least a first repeater of the one or more repeaters.

Additionally, or alternatively, the communications manager 1120 may support wireless communications in accordance with examples as disclosed herein. In some examples, the ML model manager 1125 is capable of, configured to, or operable to support a means for receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The configuration update manager 1140 is capable of, configured to, or operable to support a means for transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

In some examples, the prediction manager 1135 is capable of, configured to, or operable to support a means for determining a first predicted reference signal received power (RSRP) for a first repeater operating in the first configuration according to the first subset of machine learning parameters. In some examples, the prediction manager 1135 is capable of, configured to, or operable to support a means for determining a second predicted RSRP for a second repeater operating in the second configuration according to the second subset of machine learning parameters. In some examples, the prediction manager 1135 is capable of, configured to, or operable to support a means for determining to transmit the request based on the second predicted RSRP exceeding the first predicted RSRP by a threshold value.

In some examples, the prediction manager 1135 is capable of, configured to, or operable to support a means for determining a first predicted reference signal received power (RSRP) for a first repeater according to the first subset of machine learning parameters when the UE is at a first location within a coverage area of the first repeater. In some examples, the prediction manager 1135 is capable of, configured to, or operable to support a means for determining a second predicted RSRP for the first repeater according to the second subset of machine learning parameters when the UE is at a second location within the coverage area of the first repeater. In some examples, the prediction manager 1135 is capable of, configured to, or operable to support a means for determining to transmit the request based on the second predicted RSRP exceeding the first predicted RSRP by a threshold value. In some examples, the first configuration is associated with a first antenna array configuration of at least a first repeater of the one or more repeaters, and the second configuration is associated with a second antenna array configuration of at least the first repeater.

In some examples, the measurement manager 1145 is capable of, configured to, or operable to support a means for measuring a first subset of reference signals from the one or more repeaters according to the first configuration, and a second subset of reference signals from the one or more repeaters according to the second configuration, the second subset of reference signals transmitted during a temporary enablement of the second configuration, and where the request to update the one or more repeaters is based on the measurements.

In some examples, the ML model manager 1125 is capable of, configured to, or operable to support a means for receiving one or more values for one or more inputs for a machine learning algorithm associated with the first configuration and the second configuration, and where the request to update the one or more repeaters is further based on the one or more values.

In some examples, to support transmitting the request, the configuration update manager 1140 is capable of, configured to, or operable to support a means for transmitting a random access channel message to the network entity to request the update of the one or more repeaters from the first configuration to the second configuration. In some examples, to support transmitting the request, the configuration update manager 1140 is capable of, configured to, or operable to support a means for switching from the first configuration of the one or more repeaters to the second configuration of the one or more repeaters when the one or more request criteria are met.

In some examples, to support transmitting the request, the configuration update manager 1140 is capable of, configured to, or operable to support a means for transmitting an indication of a change in channel conditions and a change in power consumption associated with the request to update the one or more repeaters from the first configuration to the second configuration. In some examples, to support transmitting the request, the configuration update manager 1140 is capable of, configured to, or operable to support a means for receiving an indication of whether to update the one or more repeaters from the first configuration to the second configuration.

Additionally, or alternatively, the communications manager 1120 may support wireless communications in accordance with examples as disclosed herein. In some examples, the ML model manager 1125 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. In some examples, the configuration update manager 1140 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

In some examples, to support obtaining the request, the configuration update manager 1140 is capable of, configured to, or operable to support a means for obtaining a random access channel message to the network entity to request the update of the one or more repeaters from the first configuration to the second configuration. In some examples, to support obtaining the request, the repeater manager 1150 is capable of, configured to, or operable to support a means for switching the one or more repeaters from the first configuration to the second configuration responsive to the random access channel message.

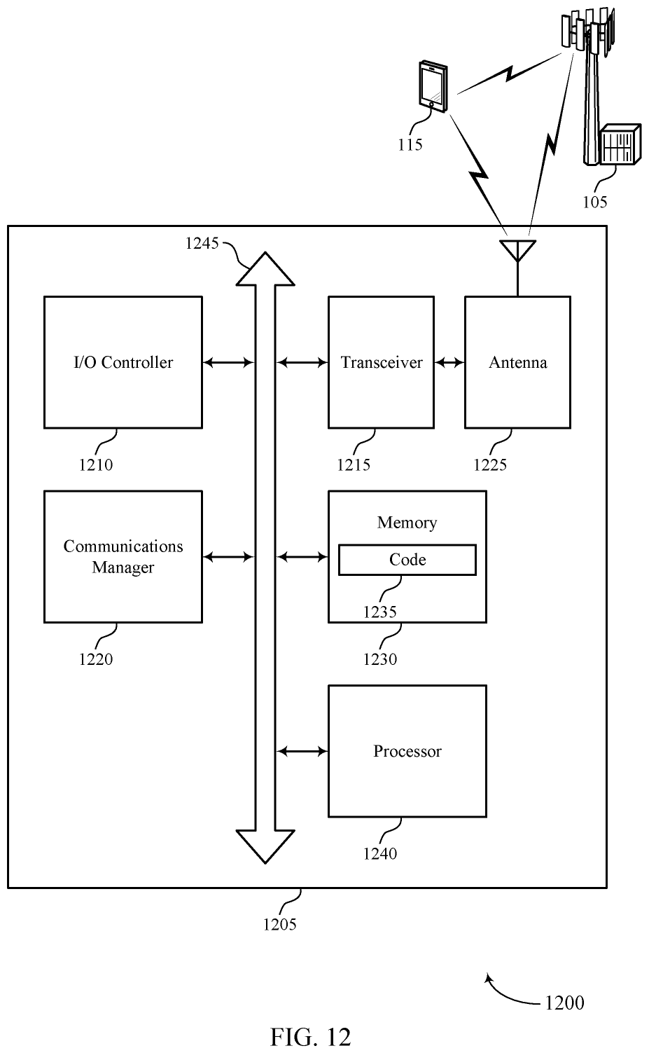

FIG. 12 shows a diagram of a system 1200 including a device 1205 that supports network controlled repeater communications based on user equipment machine learning algorithms in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting network controlled repeater communications based on user equipment machine learning algorithms). For example, the device 1205 or a component of the device 1205 may include at least one processor 1240 and at least one memory 1230 coupled with or to the at least one processor 1240, the at least one processor 1240 and the at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a set of machine learning parameters associated with wireless communications between the UE and a network entity via one or more repeaters. The communications manager 1220 is capable of, configured to, or operable to support a means for selecting a first subset of the set of machine learning parameters based on a first state of the one or more repeaters. The communications manager 1220 is capable of, configured to, or operable to support a means for communicating with the network entity, via the one or more repeaters, using one or more communications parameters that are selected based on the first subset of machine learning parameters.

Additionally, or alternatively, the communications manager 1220 may support wireless communications in accordance with examples as disclosed herein. For example, the communications manager 1220 is capable of, configured to, or operable to support a means for receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 1220 is capable of, configured to, or operable to support a means for transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters.

Additionally, or alternatively, the communications manager 1220 may support wireless communications in accordance with examples as disclosed herein. For example, the communications manager 1220 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 1220 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

By including or configuring the communications manager 1220 in accordance with examples as described herein, the device 1205 may support techniques for ML model selection, ML parameter selection, repeater configuration updates, or any combination thereof, that may provide for enhanced efficiency for determination of communications parameters, reduced power consumption, improved communication reliability, reduced latency, improved user experience, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of network controlled repeater communications based on user equipment machine learning algorithms as described herein, or the at least one processor 1240 and the at least one memory 1230 may be otherwise configured to, individually or collectively, perform or support such operations.

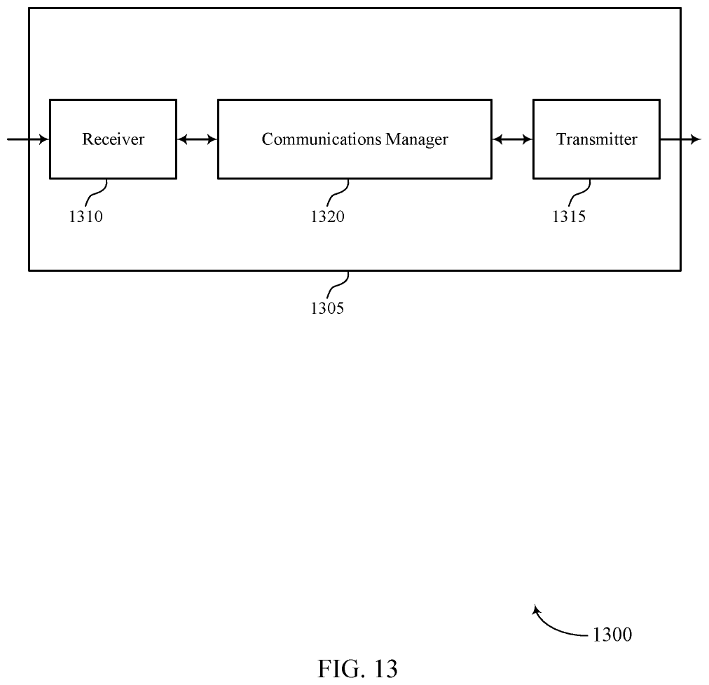

FIG. 13 shows a block diagram 1300 of a device 1305 that supports network controlled repeater communications based on user equipment machine learning algorithms in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of network controlled repeater communications based on user equipment machine learning algorithms as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters. The communications manager 1320 is capable of, configured to, or operable to support a means for communicating with the UE in accordance with the first subset of machine learning parameters when the one or more repeaters are configured in the first state. The communications manager 1320 is capable of, configured to, or operable to support a means for communicating with the UE in accordance with the second subset of machine learning parameters when the one or more repeaters are configured in the second state.

Additionally, or alternatively, the communications manager 1320 may support wireless communications in accordance with examples as disclosed herein. For example, the communications manager 1320 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 1320 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for ML model selection, ML parameter selection, repeater configuration updates, or any combination thereof, that may provide for enhanced efficiency for determination of communications parameters, reduced power consumption, improved communication reliability, reduced latency, improved user experience, and improved utilization of processing capability.

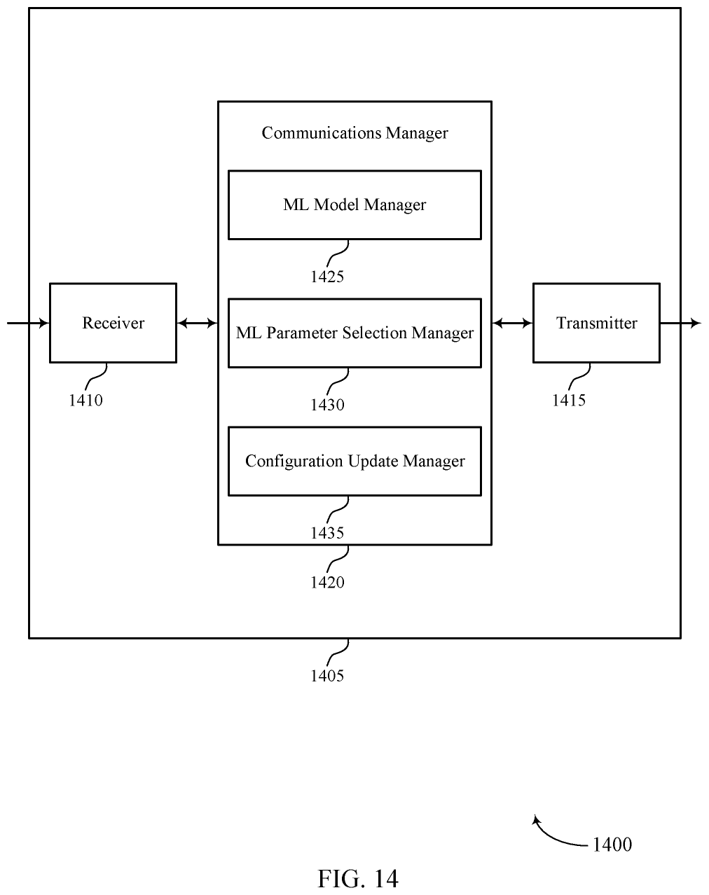

FIG. 14 shows a block diagram 1400 of a device 1405 that supports network controlled repeater communications based on user equipment machine learning algorithms in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of network controlled repeater communications based on user equipment machine learning algorithms as described herein. For example, the communications manager 1420 may include an ML model manager 1425, an ML parameter selection manager 1430, a configuration update manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The ML model manager 1425 is capable of, configured to, or operable to support a means for outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters. The ML parameter selection manager 1430 is capable of, configured to, or operable to support a means for communicating with the UE in accordance with the first subset of machine learning parameters when the one or more repeaters are configured in the first state. The ML parameter selection manager 1430 is capable of, configured to, or operable to support a means for communicating with the UE in accordance with the second subset of machine learning parameters when the one or more repeaters are configured in the second state.

Additionally, or alternatively, the communications manager 1420 may support wireless communications in accordance with examples as disclosed herein. The ML model manager 1425 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The configuration update manager 1435 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

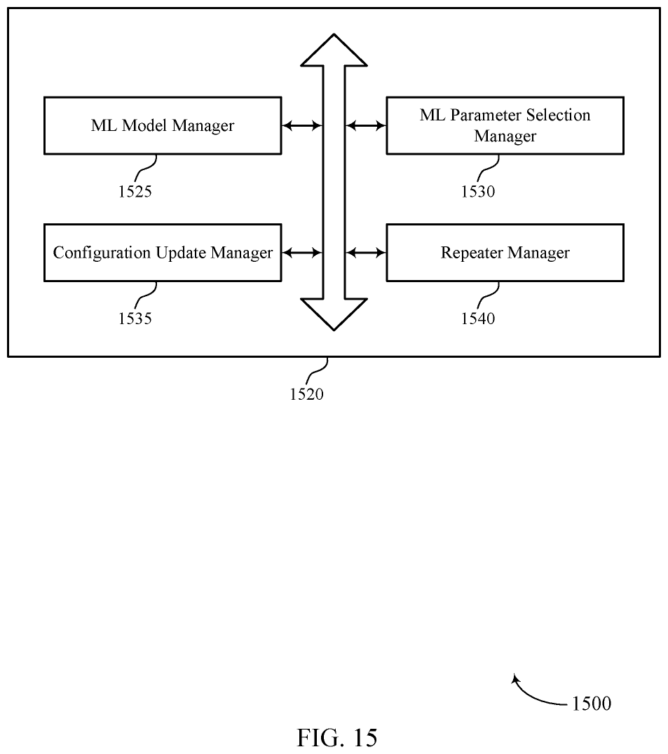

FIG. 15 shows a block diagram 1500 of a communications manager 1520 that supports network controlled repeater communications based on user equipment machine learning algorithms in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of network controlled repeater communications based on user equipment machine learning algorithms as described herein. For example, the communications manager 1520 may include an ML model manager 1525, an ML parameter selection manager 1530, a configuration update manager 1535, a repeater manager 1540, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The ML model manager 1525 is capable of, configured to, or operable to support a means for outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters. The ML parameter selection manager 1530 is capable of, configured to, or operable to support a means for communicating with the UE in accordance with the first subset of machine learning parameters when the one or more repeaters are configured in the first state. In some examples, the ML parameter selection manager 1530 is capable of, configured to, or operable to support a means for communicating with the UE in accordance with the second subset of machine learning parameters when the one or more repeaters are configured in the second state.

In some examples, to support outputting the set of machine learning parameters, the ML model manager 1525 is capable of, configured to, or operable to support a means for outputting configuration information that indicates the set of machine learning parameters, a set of states associated with the one or more repeaters, and one or more selection criteria that associates different states of the set of states with different subsets of the set of machine learning parameters, and where the set of machine learning parameters include one or more of a set of machine learning algorithms, a set of parameters associated with one or more machine learning algorithms, or any combination thereof.

Additionally, or alternatively, the communications manager 1520 may support wireless communications in accordance with examples as disclosed herein. In some examples, the ML model manager 1525 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The configuration update manager 1535 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

In some examples, to support obtaining the request, the configuration update manager 1535 is capable of, configured to, or operable to support a means for obtaining a random access channel message to the network entity to request the update of the one or more repeaters from the first configuration to the second configuration. In some examples, to support obtaining the request, the repeater manager 1540 is capable of, configured to, or operable to support a means for switching the one or more repeaters from the first configuration to the second configuration responsive to the random access channel message.

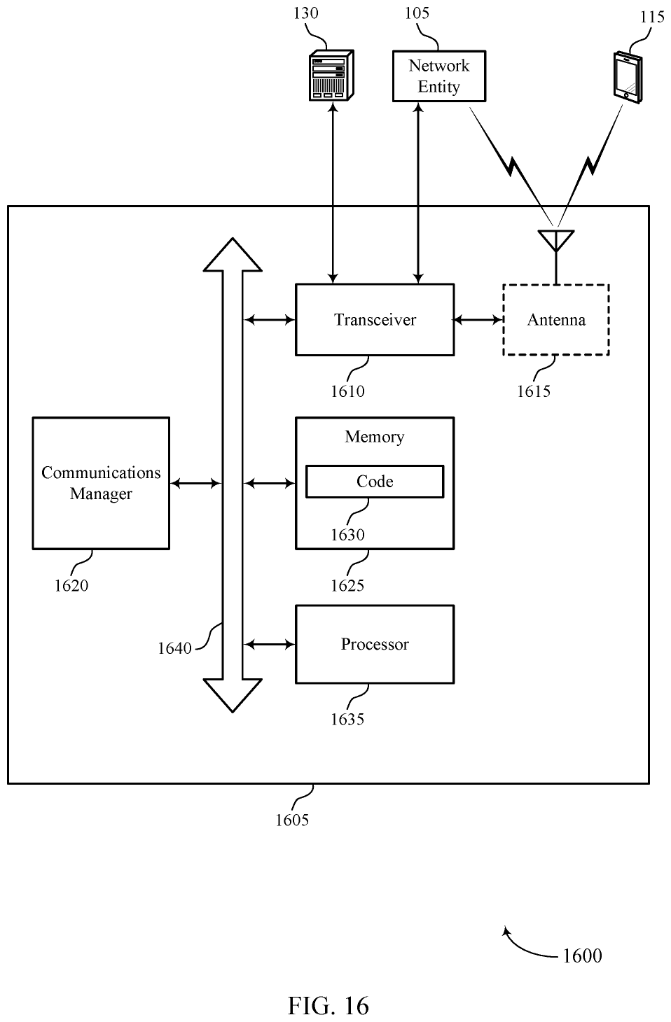

FIG. 16 shows a diagram of a system 1600 including a device 1605 that supports network controlled repeater communications based on user equipment machine learning algorithms in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting network controlled repeater communications based on user equipment machine learning algorithms). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105 (e.g., network devices), and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters. The communications manager 1620 is capable of, configured to, or operable to support a means for communicating with the UE in accordance with the first subset of machine learning parameters when the one or more repeaters are configured in the first state. The communications manager 1620 is capable of, configured to, or operable to support a means for communicating with the UE in accordance with the second subset of machine learning parameters when the one or more repeaters are configured in the second state.

Additionally, or alternatively, the communications manager 1620 may support wireless communications in accordance with examples as disclosed herein. For example, the communications manager 1620 is capable of, configured to, or operable to support a means for outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The communications manager 1620 is capable of, configured to, or operable to support a means for obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters.

By including or configuring the communications manager 1620 in accordance with examples as described herein, the device 1605 may support techniques for ML model selection, ML parameter selection, repeater configuration updates, or any combination thereof, that may provide for enhanced efficiency for determination of communications parameters, reduced power consumption, improved communication reliability, reduced latency, improved user experience, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of network controlled repeater communications based on user equipment machine learning algorithms as described herein, or the at least one processor 1635 and the at least one memory 1625 may be otherwise configured to, individually or collectively, perform or support such operations.

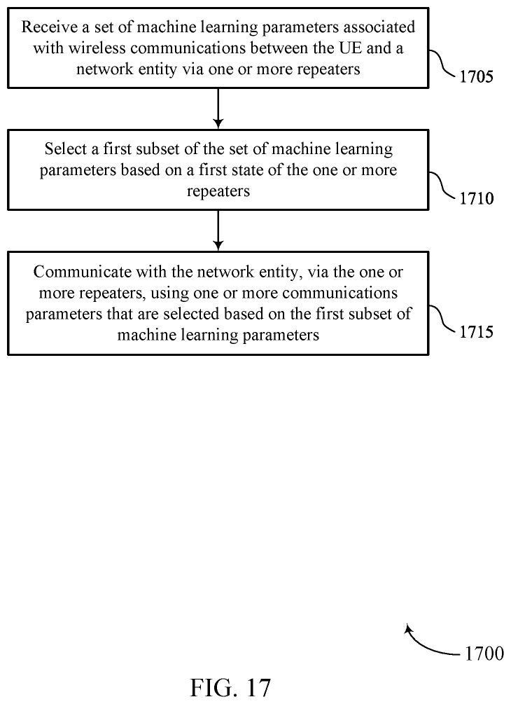

FIG. 17 shows a flowchart illustrating a method 1700 that supports network controlled repeater communications based on user equipment machine learning algorithms in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a set of machine learning parameters associated with wireless communications between the UE and a network entity via one or more repeaters. The operations of 1705 may be performed in accordance with examples as disclosed herein. In some examples, aspects of the operations of 1705 may be performed by an ML model manager 1125 as described with reference to FIG. 11.

At 1710, the method may include selecting a first subset of the set of machine learning parameters based on a first state of the one or more repeaters. The operations of 1710 may be performed in accordance with examples as disclosed herein. In some examples, aspects of the operations of 1710 may be performed by an ML parameter selection manager 1130 as described with reference to FIG. 11.

At 1715, the method may include communicating with the network entity, via the one or more repeaters, using one or more communications parameters that are selected based on the first subset of machine learning parameters. The operations of 1715 may be performed in accordance with examples as disclosed herein. In some examples, aspects of the operations of 1715 may be performed by a prediction manager 1135 as described with reference to FIG. 11.

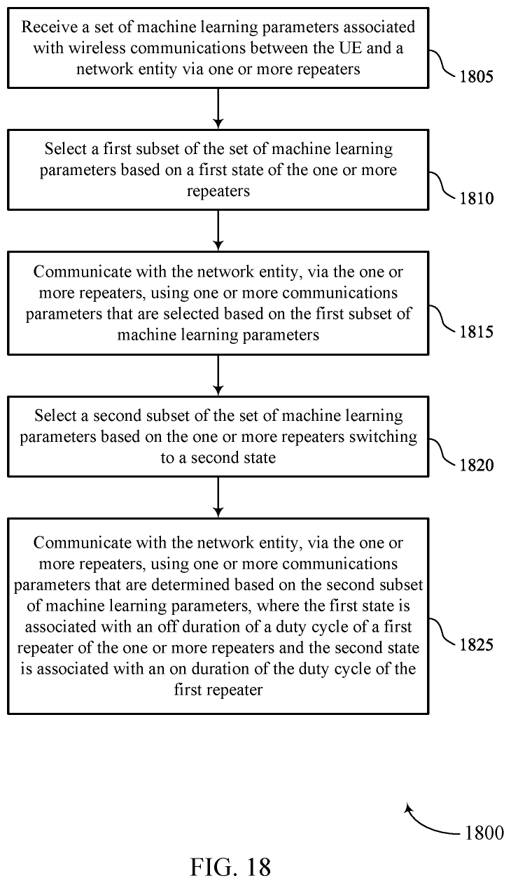

FIG. 18 shows a flowchart illustrating a method 1800 that supports network controlled repeater communications based on user equipment machine learning algorithms in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a set of machine learning parameters associated with wireless communications between the UE and a network entity via one or more repeaters. The operations of 1805 may be performed in accordance with examples as disclosed herein. In some examples, aspects of the operations of 1805 may be performed by an ML model manager 1125 as described with reference to FIG. 11.

At 1810, the method may include selecting a first subset of the set of machine learning parameters based on a first state of the one or more repeaters. The operations of 1810 may be performed in accordance with examples as disclosed herein. In some examples, aspects of the operations of 1810 may be performed by an ML parameter selection manager 1130 as described with reference to FIG. 11.

At 1815, the method may include communicating with the network entity, via the one or more repeaters, using one or more communications parameters that are selected based on the first subset of machine learning parameters. The operations of 1815 may be performed in accordance with examples as disclosed herein. In some examples, aspects of the operations of 1815 may be performed by a prediction manager 1135 as described with reference to FIG. 11.

At 1820, the method may include selecting a second subset of the set of machine learning parameters based on the one or more repeaters switching to a second state. The operations of 1820 may be performed in accordance with examples as disclosed herein. In some examples, aspects of the operations of 1820 may be performed by an ML parameter selection manager 1130 as described with reference to FIG. 11.

At 1825, the method may include communicating with the network entity, via the one or more repeaters, using one or more communications parameters that are determined based on the second subset of machine learning parameters, where the first state is associated with an off duration of a duty cycle of a first repeater of the one or more repeaters and the second state is associated with an on duration of the duty cycle of the first repeater. The operations of 1825 may be performed in accordance with examples as disclosed herein. In some examples, aspects of the operations of 1825 may be performed by a prediction manager 1135 as described with reference to FIG. 11.

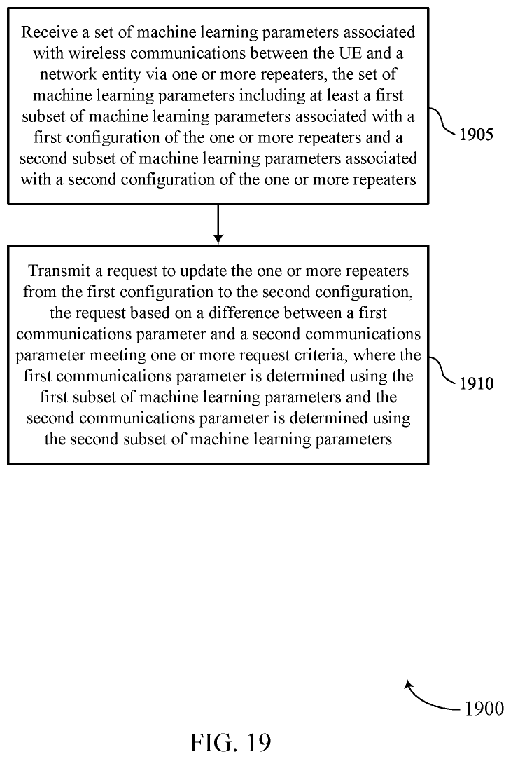

FIG. 19 shows a flowchart illustrating a method 1900 that supports network controlled repeater communications based on user equipment machine learning algorithms in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The operations of 1905 may be performed in accordance with examples as disclosed herein. In some examples, aspects of the operations of 1905 may be performed by an ML model manager 1125 as described with reference to FIG. 11.

At 1910, the method may include transmitting a request to update the one or more repeaters from the first configuration to the second configuration, the request based on a difference between a first communications parameter and a second communications parameter meeting one or more request criteria, where the first communications parameter is determined using the first subset of machine learning parameters and the second communications parameter is determined using the second subset of machine learning parameters. The operations of 1910 may be performed in accordance with examples as disclosed herein. In some examples, aspects of the operations of 1910 may be performed by a configuration update manager 1140 as described with reference to FIG. 11.

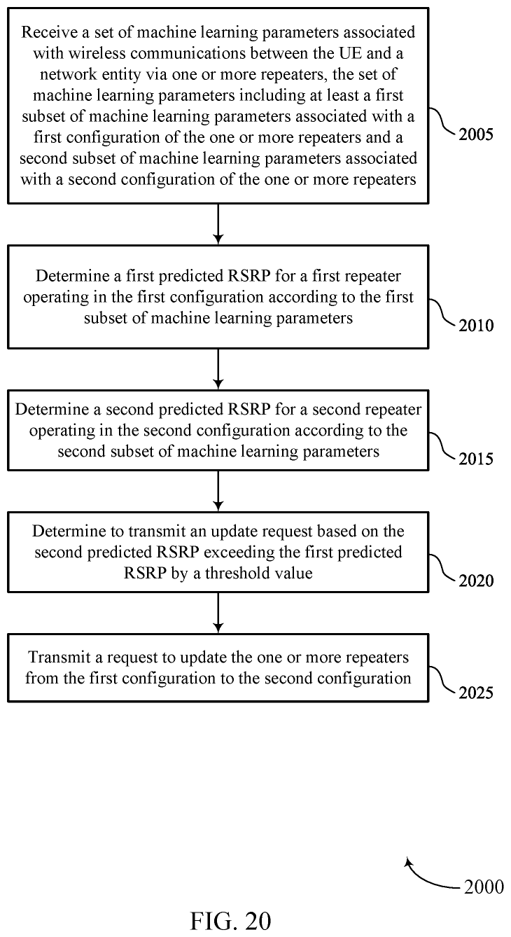

FIG. 20 shows a flowchart illustrating a method 2000 that supports network controlled repeater communications based on user equipment machine learning algorithms in accordance with one or more aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The operations of 2005 may be performed in accordance with examples as disclosed herein. In some examples, aspects of the operations of 2005 may be performed by an ML model manager 1125 as described with reference to FIG. 11.

At 2010, the method may include determining a first predicted reference signal received power (RSRP) for a first repeater operating in the first configuration according to the first subset of machine learning parameters. The operations of 2010 may be performed in accordance with examples as disclosed herein. In some examples, aspects of the operations of 2010 may be performed by a prediction manager 1135 as described with reference to FIG. 11.

At 2015, the method may include determining a second predicted RSRP for a second repeater operating in the second configuration according to the second subset of machine learning parameters. The operations of 2015 may be performed in accordance with examples as disclosed herein. In some examples, aspects of the operations of 2015 may be performed by a prediction manager 1135 as described with reference to FIG. 11.

At 2020, the method may include determining to transmit an update request based on the second predicted RSRP exceeding the first predicted RSRP by a threshold value. The operations of 2020 may be performed in accordance with examples as disclosed herein. In some examples, aspects of the operations of 2020 may be performed by a prediction manager 1135 as described with reference to FIG. 11.

At 2025, the method may include transmitting a request to update the one or more repeaters from the first configuration to the second configuration. The operations of 2025 may be performed in accordance with examples as disclosed herein. In some examples, aspects of the operations of 2025 may be performed by a configuration update manager 1140 as described with reference to FIG. 11.

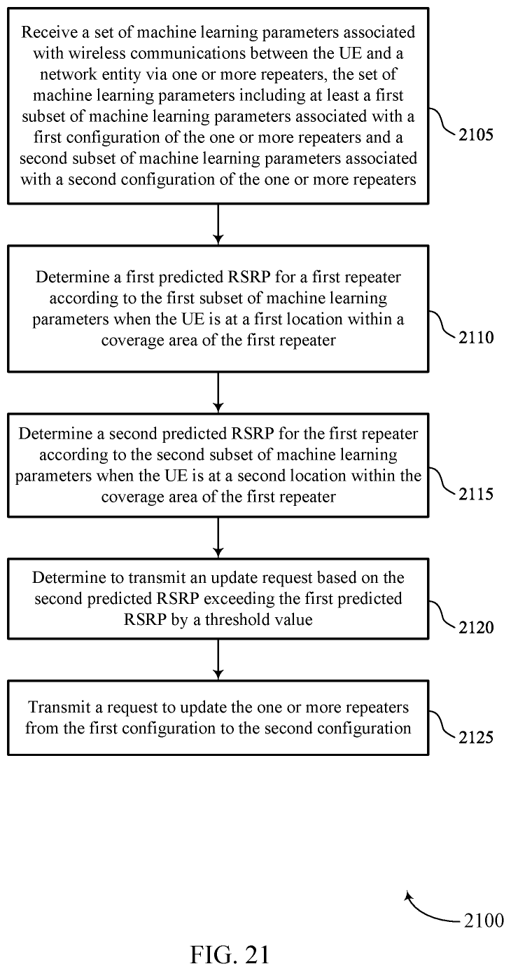

FIG. 21 shows a flowchart illustrating a method 2100 that supports network controlled repeater communications based on user equipment machine learning algorithms in accordance with one or more aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The operations of 2105 may be performed in accordance with examples as disclosed herein. In some examples, aspects of the operations of 2105 may be performed by an ML model manager 1125 as described with reference to FIG. 11.

At 2110, the method may include determining a first predicted reference signal received power (RSRP) for a first repeater according to the first subset of machine learning parameters when the UE is at a first location within a coverage area of the first repeater. The operations of 2110 may be performed in accordance with examples as disclosed herein. In some examples, aspects of the operations of 2110 may be performed by a prediction manager 1135 as described with reference to FIG. 11.

At 2115, the method may include determining a second predicted RSRP for the first repeater according to the second subset of machine learning parameters when the UE is at a second location within the coverage area of the first repeater. The operations of 2115 may be performed in accordance with examples as disclosed herein. In some examples, aspects of the operations of 2115 may be performed by a prediction manager 1135 as described with reference to FIG. 11.

At 2120, the method may include determining to transmit an update request based on the second predicted RSRP exceeding the first predicted RSRP by a threshold value. The operations of 2120 may be performed in accordance with examples as disclosed herein. In some examples, aspects of the operations of 2120 may be performed by a prediction manager 1135 as described with reference to FIG. 11.

At 2125, the method may include transmitting a request to update the one or more repeaters from the first configuration to the second configuration. The operations of 2125 may be performed in accordance with examples as disclosed herein. In some examples, aspects of the operations of 2125 may be performed by a configuration update manager 1140 as described with reference to FIG. 11.

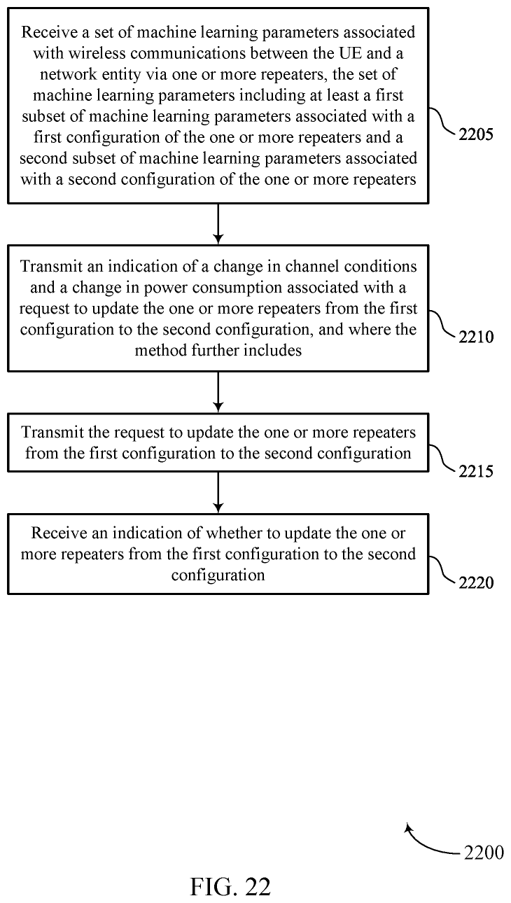

FIG. 22 shows a flowchart illustrating a method 2200 that supports network controlled repeater communications based on user equipment machine learning algorithms in accordance with one or more aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2205, the method may include receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters. The operations of 2205 may be performed in accordance with examples as disclosed herein. In some examples, aspects of the operations of 2205 may be performed by an ML model manager 1125 as described with reference to FIG. 11.

At 2210, the method may include transmitting an indication of a change in channel conditions and a change in power consumption associated with a request to update the one or more repeaters from the first configuration to the second configuration. The operations of 2210 may be performed in accordance with examples as disclosed herein. In some examples, aspects of the operations of 2210 may be performed by a configuration update manager 1140 as described with reference to FIG. 11.

At 2215, the method may include transmitting the request to update the one or more repeaters from the first configuration to the second configuration. The operations of 2215 may be performed in accordance with examples as disclosed herein. In some examples, aspects of the operations of 2215 may be performed by a configuration update manager 1140 as described with reference to FIG. 11.

At 2220, the method may include receiving an indication of whether to update the one or more repeaters from the first configuration to the second configuration. The operations of 2220 may be performed in accordance with examples as disclosed herein. In some examples, aspects of the operations of 2220 may be performed by a configuration update manager 1140 as described with reference to FIG. 11.

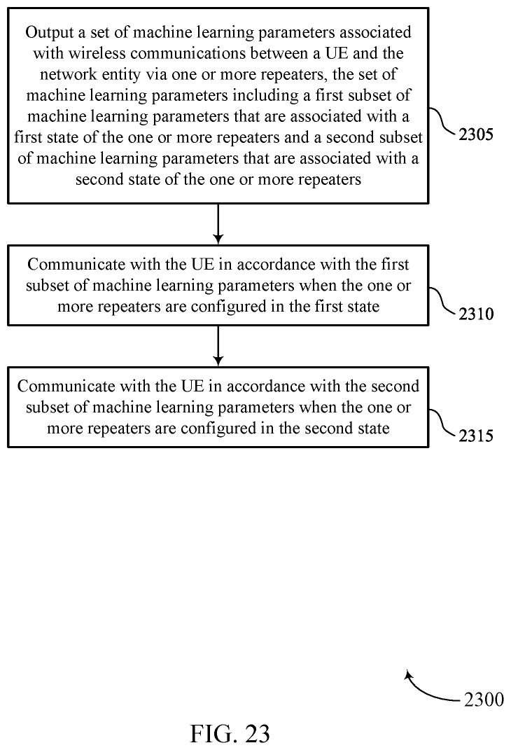

FIG. 23 shows a flowchart illustrating a method 2300 that supports network controlled repeater communications based on user equipment machine learning algorithms in accordance with one or more aspects of the present disclosure. The operations of the method 2300 may be implemented by a network entity or its components as described herein. For example, the operations of the method 2300 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2305, the method may include outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters. The operations of 2305 may be performed in accordance with examples as disclosed herein. In some examples, aspects of the operations of 2305 may be performed by an ML model manager 1525 as described with reference to FIG. 15.

At 2310, the method may include communicating with the UE in accordance with the first subset of machine learning parameters when the one or more repeaters are configured in the first state. The operations of 2310 may be performed in accordance with examples as disclosed herein. In some examples, aspects of the operations of 2310 may be performed by an ML parameter selection manager 1530 as described with reference to FIG. 15.

At 2315, the method may include communicating with the UE in accordance with the second subset of machine learning parameters when the one or more repeaters are configured in the second state. The operations of 2315 may be performed in accordance with examples as disclosed herein. In some examples, aspects of the operations of 2315 may be performed by an ML parameter selection manager 1530 as described with reference to FIG. 15.

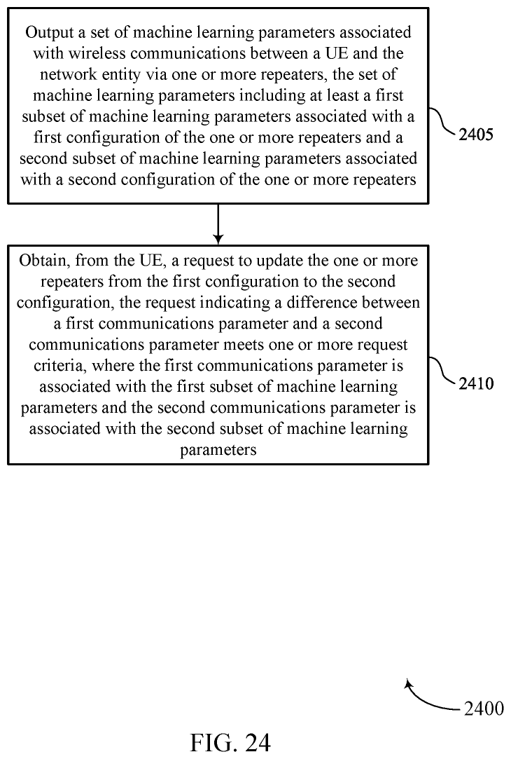

FIG. 24 shows a flowchart illustrating a method 2400 that supports network controlled repeater communications based on user equipment machine learning algorithms in accordance with one or more aspects of the present disclosure. The operations of the method 2400 may be implemented by a UE or a network entity or its components as described herein. For example, the operations of the method 2400 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2405, the method may include outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters. The operations of 2405 may be performed in accordance with examples as disclosed herein. In some examples, aspects of the operations of 2405 may be performed by an ML model manager 1125 or an ML model manager 1525 as described with reference to FIGS. 11 and 15.

At 2410, the method may include obtaining, from the UE, a request to update the one or more repeaters from the first configuration to the second configuration, the request indicating a difference between a first communications parameter and a second communications parameter meets one or more request criteria, where the first communications parameter is associated with the first subset of machine learning parameters and the second communications parameter is associated with the second subset of machine learning parameters. The operations of 2410 may be performed in accordance with examples as disclosed herein. In some examples, aspects of the operations of 2410 may be performed by a configuration update manager 1140 or a configuration update manager 1535 as described with reference to FIGS. 11 and 15.

The following provides an overview of aspects of the present disclosure:

Aspect 1: A method for wireless communications at a UE, comprising: receiving a set of machine learning parameters associated with wireless communications between the UE and a network entity via one or more repeaters; selecting a first subset of the set of machine learning parameters based at least in part on a first state of the one or more repeaters; and communicating with the network entity, via the one or more repeaters, using one or more communications parameters that are selected based at least in part on the first subset of machine learning parameters.

Aspect 2: The method of aspect 1, wherein the receiving the set of machine learning parameters comprises: receiving configuration information that indicates the set of machine learning parameters, a set of states associated with the one or more repeaters, and one or more selection criteria that associates different states of the set of states with different subsets of the set of machine learning parameters, and wherein the set of machine learning parameters include one or more of a set of machine learning algorithms, a set of parameters associated with one or more machine learning algorithms, or any combination thereof.

Aspect 3: The method of any of aspects 1 through 2, wherein the first subset of the set of machine learning parameters is selected based at least in part on a set of available repeater states of the one or more repeaters.

Aspect 4: The method of any of aspects 1 through 3, wherein the first state of the one or more repeaters is associated with a first repeater that is in an off state and a second repeater that is in an on state, and output from a machine learning algorithm associated with the first repeater is ignored when the one or more repeaters are in the first state.

Aspect 5: The method of any of aspects 1 through 4, further comprising: selecting a second subset of the set of machine learning parameters based at least in part on the one or more repeaters switching to a second state; and communicating with the network entity, via the one or more repeaters, using one or more communications parameters that are determined based at least in part on the second subset of machine learning parameters, wherein the first state is associated with an off duration of a duty cycle of a first repeater of the one or more repeaters and the second state is associated with an on duration of the duty cycle of the first repeater.

Aspect 6: The method of aspect 5, wherein the second subset of the set of machine learning parameters is further selected based at least in part on a location of the UE within a coverage area of the first repeater.

Aspect 7: The method of any of aspects 1 through 6, wherein the first subset of the set of machine learning parameters is selected based at least in part on a source of one or more reference signals received at the UE.

Aspect 8: The method of any of aspects 1 through 7, wherein the first subset of the set of machine learning parameters is selected based at least in part on an antenna array configuration of at least a first repeater of the one or more repeaters.

Aspect 9: A method for wireless communications at a UE, comprising: receiving a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters; and transmitting a request to update the one or more repeaters from the first configuration to the second configuration, the request based at least in part on a difference between a first communications parameter and a second communications parameter meeting one or more request criteria, wherein the first communications parameter is determined using the first subset of machine learning parameters and the second communications parameter is determined using the second subset of machine learning parameters.

Aspect 10: The method of aspect 9, further comprising: determining a first predicted RSRP for a first repeater operating in the first configuration according to the first subset of machine learning parameters; determining a second predicted RSRP for a second repeater operating in the second configuration according to the second subset of machine learning parameters; and determining to transmit the request based at least in part on the second predicted RSRP exceeding the first predicted RSRP by a threshold value.

Aspect 11: The method of any of aspects 9 through 10, further comprising: determining a first predicted RSRP for a first repeater according to the first subset of machine learning parameters when the UE is at a first location within a coverage area of the first repeater; determining a second predicted RSRP for the first repeater according to the second subset of machine learning parameters when the UE is at a second location within the coverage area of the first repeater; and determining to transmit the request based at least in part on the second predicted RSRP exceeding the first predicted RSRP by a threshold value.

Aspect 12: The method of any of aspects 9 through 11, wherein the first configuration is associated with a first antenna array configuration of at least a first repeater of the one or more repeaters, and the second configuration is associated with a second antenna array configuration of at least the first repeater.

Aspect 13: The method of any of aspects 9 through 12, further comprising: measuring a first subset of reference signals from the one or more repeaters according to the first configuration, and a second subset of reference signals from the one or more repeaters according to the second configuration, the second subset of reference signals transmitted during a temporary enablement of the second configuration, and wherein the request to update the one or more repeaters is based at least in part on the measurements.

Aspect 14: The method of any of aspects 9 through 13, further comprising: receiving one or more values for one or more inputs for a machine learning algorithm associated with the first configuration and the second configuration, and wherein the request to update the one or more repeaters is further based at least in part on the one or more values.

Aspect 15: The method of any of aspects 9 through 14, wherein the transmitting the request comprises: transmitting a random access channel message to the network entity to request the update of the one or more repeaters from the first configuration to the second configuration, and wherein the method further comprises: switching from the first configuration of the one or more repeaters to the second configuration of the one or more repeaters when the one or more request criteria are met.

Aspect 16: The method of any of aspects 9 through 15, wherein the transmitting the request comprises: transmitting an indication of a change in channel conditions and a change in power consumption associated with the request to update the one or more repeaters from the first configuration to the second configuration, and wherein the method further comprises: receiving an indication of whether to update the one or more repeaters from the first configuration to the second configuration.

Aspect 17: A method for wireless communications at a network entity, comprising: outputting a set of machine learning parameters associated with wireless communications between a UE and the network entity via one or more repeaters, the set of machine learning parameters including a first subset of machine learning parameters that are associated with a first state of the one or more repeaters and a second subset of machine learning parameters that are associated with a second state of the one or more repeaters; communicating with the UE in accordance with the first subset of machine learning parameters when the one or more repeaters are configured in the first state; and communicating with the UE in accordance with the second subset of machine learning parameters when the one or more repeaters are configured in the second state.

Aspect 18: The method of aspect 17, wherein the outputting the set of machine learning parameters comprises: outputting configuration information that indicates the set of machine learning parameters, a set of states associated with the one or more repeaters, and one or more selection criteria that associates different states of the set of states with different subsets of the set of machine learning parameters, and wherein the set of machine learning parameters include one or more of a set of machine learning algorithms, a set of parameters associated with one or more machine learning algorithms, or any combination thereof.

Aspect 19: A method for wireless communications at a network entity, comprising: outputting a set of machine learning parameters associated with wireless communications between a UE and the network entity via one or more repeaters, the set of machine learning parameters including at least a first subset of machine learning parameters associated with a first configuration of the one or more repeaters and a second subset of machine learning parameters associated with a second configuration of the one or more repeaters; and obtaining, from the UE, a request to update the one or more repeaters from the first configuration to the second configuration, the request indicating a difference between a first communications parameter and a second communications parameter meets one or more request criteria, wherein the first communications parameter is associated with the first subset of machine learning parameters and the second communications parameter is associated with the second subset of machine learning parameters.

Aspect 20: The method of aspect 19, wherein the obtaining the request comprises: obtaining a random access channel message to the network entity to request the update of the one or more repeaters from the first configuration to the second configuration, and wherein the method further comprises: switching the one or more repeaters from the first configuration to the second configuration responsive to the random access channel message.

Aspect 21: A UE for wireless communications, comprising one or more memories storing processor-executable code, and one or more processors coupled with the one or more memories and individually or collectively operable to execute the code to cause the UE to perform a method of any of aspects 1 through 8.

Aspect 22: A UE for wireless communications, comprising at least one means for performing a method of any of aspects 1 through 8.

Aspect 23: A non-transitory computer-readable medium storing code for wireless communications, the code comprising instructions executable by one or more processors to perform a method of any of aspects 1 through 8.

Aspect 24: A UE for wireless communications, comprising one or more memories storing processor-executable code, and one or more processors coupled with the one or more memories and individually or collectively operable to execute the code to cause the UE to perform a method of any of aspects 9 through 16.

Aspect 25: A UE for wireless communications, comprising at least one means for performing a method of any of aspects 9 through 16.

Aspect 26: A non-transitory computer-readable medium storing code for wireless communications, the code comprising instructions executable by one or more processors to perform a method of any of aspects 9 through 16.

Aspect 27: A network entity for wireless communications, comprising one or more memories storing processor-executable code, and one or more processors coupled with the one or more memories and individually or collectively operable to execute the code to cause the network entity to perform a method of any of aspects 17 through 18.

Aspect 28: A network entity for wireless communications, comprising at least one means for performing a method of any of aspects 17 through 18.

Aspect 29: A non-transitory computer-readable medium storing code for wireless communications, the code comprising instructions executable by one or more processors to perform a method of any of aspects 17 through 18.

Aspect 30: A network entity for wireless communications, comprising one or more memories storing processor-executable code, and one or more processors coupled with the one or more memories and individually or collectively operable to execute the code to cause the network entity to perform a method of any of aspects 19 through 20.

Aspect 31: A network entity for wireless communications, comprising at least one means for performing a method of any of aspects 19 through 20.

Aspect 32: A non-transitory computer-readable medium storing code for wireless communications, the code comprising instructions executable by one or more processors to perform a method of any of aspects 19 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a set of machine learning parameters associated with wireless communications between the UE and a network entity via one or more repeaters;
select a first subset of the set of machine learning parameters based at least in part on a first state of the one or more repeaters; and
communicate with the network entity, via the one or more repeaters, using one or more communications parameters that are selected based at least in part on the first subset of the set of machine learning parameters.

2. The UE of claim 1, wherein, to receive the set of machine learning parameters, the one or more processors are individually or collectively operable to execute the code to cause the UE to:
receive configuration information that indicates the set of machine learning parameters, a set of states associated with the one or more repeaters, and one or more selection criteria that associates different states of the set of states with different subsets of the set of machine learning parameters, and wherein the set of machine learning parameters include one or more of a set of machine learning algorithms, a set of parameters associated with one or more machine learning algorithms, or any combination thereof.

3. The UE of claim 1, wherein the first subset of the set of machine learning parameters is selected based at least in part on a set of available repeater states of the one or more repeaters.

4. The UE of claim 1, wherein the first state of the one or more repeaters is associated with a first repeater that is in an off state and a second repeater that is in an on state, and output from a machine learning algorithm associated with the first repeater is ignored when the one or more repeaters are in the first state.

5. The UE of claim 1, wherein the one or more processors are individually or collectively further operable to execute the code to cause the UE to:
select a second subset of the set of machine learning parameters based at least in part on the one or more repeaters switching to a second state; and
communicate with the network entity, via the one or more repeaters, using one or more communications parameters that are determined based at least in part on the second subset of the set of machine learning parameters, wherein the first state is associated with an off duration of a duty cycle of a first repeater of the one or more repeaters and the second state is associated with an on duration of the duty cycle of the first repeater.

6. The UE of claim 5, wherein the second subset of the set of machine learning parameters is further selected based at least in part on a location of the UE within a coverage area of the first repeater.

7. The UE of claim 1, wherein the first subset of the set of machine learning parameters is selected based at least in part on a source of one or more reference signals received at the UE.

8. The UE of claim 1, wherein the first subset of the set of machine learning parameters is selected based at least in part on an antenna array configuration of at least a first repeater of the one or more repeaters.

9. A user equipment (UE), comprising:
one or more memories storing processor-executable code; and
one or more processors coupled with the one or more memories and individually or collectively operable to execute the code to cause the UE to:
receive a set of machine learning parameters associated with wireless communications between the UE and a network entity via one or more repeaters, the set of machine learning parameters including at least a first subset of machine learning parameters associated with a first configuration of the one or more repeaters and a second subset of machine learning parameters associated with a second configuration of the one or more repeaters; and
transmit a request to update the one or more repeaters from the first configuration to the second configuration, the request based at least in part on a difference between a first communications parameter and a second communications parameter meeting one or more request criteria, wherein the first communications parameter is determined using the first subset of machine learning parameters and the second communications parameter is determined using the second subset of machine learning parameters.

10. The UE of claim 9, wherein the one or more processors are individually or collectively further operable to execute the code to cause the UE to:
determine a first predicted reference signal received power (RSRP) for a first repeater operating in the first configuration according to the first subset of machine learning parameters;
determine a second predicted RSRP for a second repeater operating in the second configuration according to the second subset of machine learning parameters; and
determine to transmit the request based at least in part on the second predicted RSRP exceeding the first predicted RSRP by a threshold value.

11. The UE of claim 9, wherein the one or more processors are individually or collectively further operable to execute the code to cause the UE to:
determine a first predicted reference signal received power (RSRP) for a first repeater according to the first subset of machine learning parameters when the UE is at a first location within a coverage area of the first repeater;
determine a second predicted RSRP for the first repeater according to the second subset of machine learning parameters when the UE is at a second location within the coverage area of the first repeater; and
determine to transmit the request based at least in part on the second predicted RSRP exceeding the first predicted RSRP by a threshold value.

12. The UE of claim 9, wherein the first configuration is associated with a first antenna array configuration of at least a first repeater of the one or more repeaters, and the second configuration is associated with a second antenna array configuration of at least the first repeater.

13. The UE of claim 9, wherein the one or more processors are individually or collectively further operable to execute the code to cause the UE to:
measure a first subset of reference signals from the one or more repeaters according to the first configuration, and a second subset of reference signals from the one or more repeaters according to the second configuration, the second subset of reference signals transmitted during a temporary enablement of the second configuration, and wherein the request to update the one or more repeaters is based at least in part on the measurements.

14. The UE of claim 9, wherein the one or more processors are individually or collectively further operable to execute the code to cause the UE to:
receive one or more values for one or more inputs for a machine learning algorithm associated with the first configuration and the second configuration, and wherein the request to update the one or more repeaters is further based at least in part on the one or more values.

15. The UE of claim 9, wherein, to transmit the request, the one or more processors are individually or collectively operable to execute the code to cause the UE to:
transmit a random access channel message to the network entity to request the update of the one or more repeaters from the first configuration to the second configuration, and:
switch from the first configuration of the one or more repeaters to the second configuration of the one or more repeaters when the one or more request criteria are met.

16. The UE of claim 9, wherein, to transmit the request, the one or more processors are individually or collectively operable to execute the code to cause the UE to:
transmit an indication of a change in channel conditions and a change in power consumption associated with the request to update the one or more repeaters from the first configuration to the second configuration, and:
receive an indication of whether to update the one or more repeaters from the first configuration to the second configuration.

17. A method for wireless communications at a user equipment (UE), comprising:
receiving a set of machine learning parameters associated with wireless communications between the UE and a network entity via one or more repeaters;
selecting a first subset of the set of machine learning parameters based at least in part on a first state of the one or more repeaters; and
communicating with the network entity, via the one or more repeaters, using one or more communications parameters that are selected based at least in part on the first subset of the set of machine learning parameters.

18. The method of claim 17, wherein the receiving the set of machine learning parameters comprises:
receiving configuration information that indicates the set of machine learning parameters, a set of states associated with the one or more repeaters, and one or more selection criteria that associates different states of the set of states with different subsets of the set of machine learning parameters, and wherein the set of machine learning parameters include one or more of a set of machine learning algorithms, a set of parameters associated with one or more machine learning algorithms, or any combination thereof.

19. The method of claim 17, wherein the first subset of the set of machine learning parameters is selected based at least in part on a set of available repeater states of the one or more repeaters.

20. The method of claim 17, further comprising:
selecting a second subset of the set of machine learning parameters based at least in part on the one or more repeaters switching to a second state; and
communicating with the network entity, via the one or more repeaters, using one or more communications parameters that are determined based at least in part on the second subset of the set of machine learning parameters, wherein the first state is associated with an off duration of a duty cycle of a first repeater of the one or more repeaters and the second state is associated with an on duration of the duty cycle of the first repeater.
